(19) United States
(12) Patent Application Publication
(10) Pub. No.: US 2025/0252292 A1
(43) Pub. Date: Aug. 7, 2025

(54) DIRECT POSTERIOR PREFERENCE FINE-TUNING

(71) Applicant: DeepMind Technologies Limited, London (GB)

(72) Inventors: Gil Shamir, Sewickley, PA (US); Yonghui Wu, Palo Alto, CA (US)

(21) Appl. No.: 18/433,890

(22) Filed: Feb. 6, 2024

(51) Int. Cl. G06N 3/0455; G06N 3/09

(52) U.S. Cl. CPC G06N 3/0455; G06N 3/09

(57) ABSTRACT

Provided is a methodology for direct supervised preference fine-tuning of sequence processing models such as, for example, so-called large language models (LLMs) and large multimodal models (LMMs). The proposed approaches can fine-tune the model to directly predict the posterior token probabilities conditioned on a positive preference of the sequence for which the token is the last token on a sequence of tokens that are the prefix to the sequence. This method offers a simpler fine-tuning approach that directly generates the desired posteriors for use in decoding, without requiring additional inference per vocabulary token at decoding time.

### FIELD

The present disclosure relates generally to machine learning processes and machine-learned devices and systems. More particularly, the present disclosure relates to a methodology for direct preference fine-tuning of sequence processing models such as large language models.

### BACKGROUND

In the field of machine learning and artificial intelligence, sequence processing models such as so-called large language models (LLMs) or large multimodal models (LMMs) have been widely used to perform tasks like language translation, speech recognition, and image captioning. A common challenge in these applications lies in aligning the output of such models to specific tasks or preferences, which is often achieved by fine-tuning the model on a task-specific or preference-specific dataset.

In practice, however, it can be challenging to effectively fine-tune these models due to the absence of suitable datasets that align the responses of the model to a specific preference or control task. For instance, supervised learning approaches generally require a large amount of labeled data, which may not always be readily available or feasible to obtain, especially in cases where the desired output is specific to a user or subject to continuously changing requirements.

Various tasks for which LLMs are to be aligned are more subjective to human preferences, and alignment datasets do not always exist for such tasks. For instance, language models should be aligned to provide answers that are factually correct, creative, nontoxic, or are compliant to specific sentiments.

Existing methodologies such as Reinforcement Learning with Human Feedback (RLHF) and controlled text generation, which have been proposed to address this challenge, can be resource-intensive and complex. RLHF requires training iterations between training an expensive transformer-based reward model and an instantiation of the LLM to iteratively (online) fine tune the model. It also requires storing the base model parameters throughout the process together with the parameters that fine-tuning optimizes. Controlled text generation methods are expensive in the generation (decoding) state because they require both the inference of the LLM and that of the preference model for generation of each token.

These methods often require a compromise between best predictions for the training dataset and maximizing the reward, which may not always yield the most desired or efficient results, and may overfit toward a reward model Such overfitting often eliminates or reduces the model's ability to keep exploring. In tasks of creativity, for instance, eliminating such exploration is not desired.

Furthermore, methods like Direct Preference Optimization (DPO) are restricted to specific pairwise ranking loss, limiting their applicability and flexibility in handling different types of preference labels or ranking tasks.

Therefore, a technical problem exists in providing an efficient and flexible fine-tuning approach for sequence processing models that can effectively align the model's outputs to specific tasks or preferences, especially in the absence of a comprehensive task-specific or preference-specific dataset. This problem is further complicated by the need to balance between the computational efficiency of the fine-tuning process, the flexibility of the model in handling different types of preference labels or ranking tasks, and the effectiveness of the model in generating outputs that align with the specific tasks or preferences.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for performing direct posterior preference fine-tuning of a sequence processing model. The method includes obtaining, by a computing system comprising one or more computing devices, a training tuple comprising a training sequence and a preference label associated with the training sequence, wherein the training sequence comprises a sequence of tokens. The method includes processing, by the computing system, at least a portion of the sequence of tokens in the training sequence with the sequence processing model to generate, as an output of a posterior prediction layer of the sequence processing model, a plurality of posterior scores respectively for a plurality of candidate token values included in a token vocabulary. The plurality of posterior scores are conditioned on the preference label being a positive label. The method includes evaluating, by the computing system, one or more loss functions based on the plurality of posterior scores and the preference label. Evaluating a first loss function of the one or more loss functions includes determining, by the computing system and based on the plurality of posterior scores, a joint probability for at least an actual token value of the plurality of candidate token values and the preference label being a positive label. Determining the joint probability includes aggregating all joint probabilities of the candidate token values and the preference label being a negative label to an additional aggregated symbol. The method includes modifying, by the computing system, one or more values of one or more parameters of the sequence processing model based on the one or more loss functions including the first loss function.

Another example aspect of the present disclosure is directed to a computing system configured to perform sequence processing with improved computational efficiency. The computing system includes one or more processors and one or more non-transitory computer-readable media. The one or more non-transitory computer-readable media collectively store: a machine-learned sequence processing model comprising a posterior prediction layer configured to generate a plurality of posterior scores respectively for a plurality of candidate token values included in a token vocabulary, the plurality of posterior scores conditioned on a positive preference. The one or more non-transitory computer-readable media collectively store: computer-executable instructions that, when executed by the one or more processors, cause the computing system to perform operations. The operations include obtaining an input prompt; processing the input prompt with the machine-learned sequence processing model to generate, as an output the posterior prediction layer, the plurality of posterior scores respectively for the plurality of candidate token values included in the token vocabulary; transforming the plurality of posterior scores into a plurality of posterior probabilities respectively for the plurality of candidate token values; and sampling an output token for inclusion in an output sequence of tokens based on the plurality of posterior probabilities respectively for the plurality of candidate token values.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIGS. 1A-C illustrate graphical diagrams of an example approach for direct posterior preference fine tuning with joint token and preference predictions according to example implementations of aspects of the present disclosure;

FIG. 2 illustrates a graphical diagram of an example approach for direct posterior preference gated low-rank fine tuning according to example implementations of aspects of the present disclosure;

FIG. 3 illustrates a graphical diagram of an example approach for direct posterior preference fine tuning that leverages a normalizer score according to example implementations of aspects of the present disclosure;

FIG. 4 illustrates a graphical diagram of an example approach for multi-head, multi-objective direct posterior preference low-rank adaptation fine tuning according to example implementations of aspects of the present disclosure;

FIG. 5 illustrates a graphical diagram of an example approach for multi-head, multi-objective direct posterior preference gated low-rank fine tuning according to example implementations of aspects of the present disclosure;

FIG. 6 illustrates a graphical diagram of an example approach for single-head, multi-objective direct posterior preference fine tuning according to example implementations of aspects of the present disclosure;

FIG. 7 illustrates a graphical diagram of an example approach for single-head, multi-objective direct posterior preference prefix prompt fine tuning according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

Generally, the present disclosure is directed to a methodology for direct supervised preference fine-tuning of sequence processing models such as, for example, so-called large language models (LLMs) and large multimodal models (LMMs). Certain existing methods such as Reinforcement Learning with Human Feedback (RLHF) require a reinforcement learning loop and a separate reward model, which can be complex and resource-intensive. Additionally, recent simplifications of RLHF like Direct Preference Optimization (DPO) are hardwired to a specific pairwise ranking loss, which can limit their applicability.

In contrast the technology described in the present disclosure, which can be referred to as Direct Posterior Preference Fine-Tuning (DPPFT), fine-tunes the model to directly predict the posterior token probabilities conditioned on a positive preference. This method offers a simpler fine-tuning approach that directly generates the desired posteriors for use in decoding, without requiring additional inference per vocabulary token at decoding time.

Furthermore, the present disclosure proposes several architecture options for the fine-tuned parameters, including Low Rank Adaptation (LoRA), gated tuning, and prefix prompt tuning. These architectures can be applied with a small set of parameters added to the network, freezing the parameters of the pre-trained model. This makes the fine-tuning process more efficient and manageable, especially for highly-parameterized sequence processing models.

Thus, the present disclosure provides a more straightforward and efficient approach to fine-tuning sequence processing models, offering potential improvements in computational efficiency, model adaptability, and decoding performance.

More particularly, example aspects of the present disclosure are directed to computer-implemented systems and methods for performing direct posterior preference fine-tuning of a sequence processing model. Sequence processing models can be used in various applications such as, for example, language translation, speech recognition, summarization, and image captioning. Sequence models can also be used in images, audio, video, or for other types of data, and in multi-modal setups that combine the different data types. For example, in language translation, the sequence processing model can be trained to generate translations that are more aligned with user preferences. In speech recognition, the model can be fine-tuned to better understand and transcribe user speech. In image captioning, the model can be adjusted to generate captions that more accurately describe the content of images. In summarization, the model can be used to generate text or content summaries, and fine-tuning can be applied to make them more factual, creative, express some sentiments, or remove toxicity.

Specifically, an example training system can obtain a training tuple comprising a training sequence and a preference label associated with the training sequence. The training sequence can be a sequence of tokens, which can be words, images, sounds, or any other type of tokenized data. For instance, in a language translation application, the tokens can be words or phrases in the source language. In an image captioning application, the tokens can be image features, pixels, or patches extracted from the image.

In some implementations, an initial portion of the training sequence can be considered a prefix input while a remainder of the training sequence can be considered a target output. Alternatively, the data is generated in response to some text or question that is an actual prompt. The preference label can provide some indication of a preference level of the training sequence. For example, the preference label can be a binary label indicating binary preference (such as “thumbs-up” or “thumbs-down”), a multi-class label indicating a graded amount of preference, a relative preference label indicating a relative preference between the training sequence and one or more other training sequences (e.g., pairwise or listwise), indicating whether the sequence is preferred over its pair or other sequences in the list and/or other formats. In general, a preference label that indicates in some manner that the training sequence is preferred can be referred to as a positive label.

The sequence processing model can process at least a portion of the sequence of tokens in the training sequence. For example, the sequence processing model can process the prefix input and attempt to predict a next sequential token that is included in the target output (which may also be referred to as the “actual” token). This process can be performed sequentially on a per-token basis, where at each instance the target token from the prior instance is added to the prefix input and the model seeks to predict the next subsequent token in the target output, referred to as output sequence, completion, generation, or decoded sequence.

Specifically, by processing the training sequence, the sequence processing model can generate a plurality of target scores for a plurality of candidate token values included in a token vocabulary. According to an aspect of the present disclosure, those targets can be computed as posterior scores. These posterior scores are conditioned on the preference label being a positive label. The training system can then evaluate one or more loss functions based on the plurality of posterior scores and the preference label.

According to an aspect of the present disclosure, this evaluation can include determining a joint probability for at least the actual token value of the plurality of candidate token values and the preference label being a positive label. For example, the evaluation can be performed in the context of fine-tuning of the model to the specified preferences. For example, in a language translation application, the actual token value can be the actual word or phrase in the target language seen in sequences generated for the fine-tuning task or presented in a fine-tuning dataset. In an image captioning application, the actual token value can be the actual word or phrase that is present in a fine-tuning training sequence which accurately describes the content of the image.

Furthermore, according to another aspect of the present disclosure, in some implementations, a joint probability (e.g., a special joint probability mass function) can be determined by either implicitly or explicitly aggregating all joint probabilities of the candidate token values and the preference label being a negative label to an additional aggregated symbol. For example, this aggregated symbol can be added to the set of vocabulary symbols for which the joint probability with a positive preference label is being trained.

The training system can modify values of one or more parameters of the sequence processing model based on the one or more loss functions. This modification can be performed using various optimization algorithms such as gradient descent, stochastic gradient descent, or any other suitable algorithm. The parameters of the sequence processing model can include weights and biases of the model's layers, or any other suitable parameters.

In some example implementations, the training system can evaluate the one or more loss functions and modify the one or more values of the one or more parameters of the sequence processing model based on the one or more loss functions on a per-token incremental basis. This allows the model to be updated for each token included in the training sequence (e.g., in the target output, completion or generation portion of the training sequence).

After training, the sequence processing model can be deployed to perform inference. During inference, the posterior scores output by the posterior prediction layer of the sequence processing model can be used to directly model a posterior probability of the candidate token values given an input prompt. For example, output tokens can be directly sampled according to the posterior probability.

The proposed techniques provide significant technical effects and benefits. One example technical effect is the increased computational efficiency in fine-tuning sequence processing models, such as LLMs and LMMs. By directly predicting the posterior token probabilities conditioned on a positive preference, the methodology significantly reduces the complexity associated with traditional techniques like RLHF. In particular, the DPPFT methodology eliminates the need for training an additional, separate reward model, which is a common requirement in certain existing techniques. This improvement considerably reduces the consumption of computational resources, including memory and processing power. This reduction is primarily due to the avoidance of numerous training cycles that would otherwise be dedicated to training the separate reward model and for fine-tuning the sequence processing model, an often resource-intensive process. Consequently, the proposed approach allows for more efficient use of computational resources.

Furthermore, in contrast to existing techniques that require computation of additional layers at deployment, the present technology leverages the direct modeling of posterior probabilities using posterior scores. For example, certain prior approaches append additional control layers onto the model and then compute these layers at inference time. In contrast the present disclosure eliminates the need for computing additional control layers during inference, resulting in a reduction in the usage of computational resources. This technical effect enhances the efficiency and speed of the deployment process, providing a significant advantage, particularly in applications where computational resources are limited or expensive.

Another example technical effect lies in the model's enhanced flexibility in handling different types of preference labels or ranking tasks. For example, certain prior approaches are hardwired to handle only a certain form of label and loss. For example, the DPO approach is hardwired to a specific pairwise ranking loss. In contrast the proposed techniques are not hardwired to a specific loss, but instead can be applied to more general settings, including listwise preferences over a list of sequences, and nonbinary graded preference labels in pointwise, pairwise, or listwise sense. This increased adaptability represents a significant technical improvement over existing techniques, enabling the model to be more widely applicable across different tasks, scenarios, and structures of training data.

The proposed techniques also offer the technical effect of reducing the storage requirements during the fine-tuning process. By directly generating the desired posteriors for use in decoding, some implementations of the present disclosure obviate the need to store the base or “reference” model parameters throughout the process, which significantly reduces the storage requirements, which represents a further technical benefit.

### Example Problem Space and Drawbacks of Alternative Approaches

A key step for utilization of pretrained sequence processing models (e.g., LLMs and LMMs) is their alignment to specific tasks or to specific preferences, where their predictions are directed to prefer specific solutions aligned with the task over ones that are not. Alignment to a specific task can be achieved by fine-tuning the model on a task-specific dataset. An alternative form of alignment focuses on directing a pretrained model towards a specific preference or control task. In this form, fine-tuning may not have an existing dataset with which to align the responses of the model. Instead, the pretrained model is used to sample sequences, which may then be labeled by humans (or by models) with a preference label. The preference label may designate which sequences satisfy some preference and which do not, or alternatively, may give relative ratings or rankings among sequences preferring one sequence over another to the specific task.

Certain methodologies, such as RLHF and controlled text generation have been proposed to address this form of alignment. RLHF trains a reward model based on human preference labels either individually assigned to sequences or relatively assigned to rank sequences. Then, a reward model is used on newly-generated sequences to fine-tune the models' parameters to compromise between best predictions for the training dataset and maximizing the reward. In controlled text generation, a control variable model is trained (separately or in tandem with the language model) and is used during decoding time to give a posterior per token prediction conditioned on the event that the prefix sequence of that token up to that token will be the prefix of a preferred or desired sequence. Various methods have been proposed to simplify various components of these methodologies. For example, DPO mathematically models the reinforcement learning steps of RLHF with pairwise ranking to give a supervised approach that optimizes towards a loss that balances between the pretrained model prediction and an implicit reward model (where balancing is a function of a tunable hyper parameter).

All of the methods described in the paragraph above exhibit certain complexity challenges. For example, RLHF requires a reinforcement loop which trains a reward model and then applies it to fine-tune the model parameters. It also requires storing the base (pretrained) model parameters throughout the process together with the parameters that fine-tuning optimizes. Then, the fine-tuned parameters replace the base or reference model parameters in the deployed model for decoding. While DPO skips this reinforcement loop, it still requires iterating through the two sets of parameters. DPO is also hard-wired to apply the preferences only through a pairwise ranking loss, which restricts the method only to pairwise preference labels that relate pairs of sequences. Controlled decoding requires predicting the probabilities of the next token value for each token in the vocabulary (or at least the next top-K tokens) together with the preference label probabilities for each of these token values during decoding, which requires additional layer(s) of computation.

One important aspect of fine-tuning of sequence processing models is the parameter space dimensionality. Modeling can be perceived as if it hierarchically partitions the parameter space into subspaces each representing a subclass of the complete model class. A set of parameters is used to determine the subspace/subclass, and another set to determine the parameters for that subclass. A pre-trained model can include the full set of parameters explaining the full space. Fine-tuning can be perceived as a first step of the hierarchical approach, which focuses the model on a subclass for the particular preference. For practical datasets and fine-tuning, the parameter richness needed to select a subclass is rather small, whereas the cost of parameters within a subclass constitutes the more significant component of the model. This implies that fine-tuning can be achieved with a rather small set of parameters that focus the model towards the parameters it pre-trained for the desired subclass. Techniques, such as Low Rank Adaptation (LoRA) take advantage of such a realization. Considering specific preference examples in language models, such as non-toxicity, one can easily argue that there is a relatively small set of language phrases that distinguish between an acceptable and a non-acceptable sequence. Thus these can be modeled by a relatively small set of parameters. An interesting question is how to align these parameters so as to capture the fine-tuning model space partitioning with the fewest parameters. The present disclosure hypothesizes that for preference cases that can be directly expressed by language previously observed in the pre-trained dataset, the simplest subspace selection may be achievable by language prompt of phrases, using approaches of Prompt or Prefix tuning. On the other hand, in cases where preference is not aligned with the language observed parameters and the fine-tuning model must generalize on dimensions it hasn't seen in pre-training, techniques like LoRA may have an advantage. In any case, the DPPFT techniques of the present disclosure can optionally be applied to learn a small set of parameters to be used for fine-tuning, while freezing the parameters learned by the pre-trained model. However, note that the approach presented for DPPFT can also be used while allowing some larger amount (e.g., all) of the pre-trained parameters to fine-tune as well.

### Example Notation

Given a prompt or prefix (vector) x, a sequence processing model can generate a sequence y=y_{≤T} of up to T tokens yₜ, t≤T, where yₜ=v∈V is taken from a vocabulary of M=|V| token values v∈V. One example architecture that can be used to implement a sequence processing model is a transformer model and its variants.

This notation uses y_{<t} to denote the concatenation of the prompt or prefix x with all generated tokens preceding the t-th token yₜ. This notation uses y_{≤t} to denote the inclusive sequence up to and including the t-th token. All the parameters of a model can be represented by the parameter vector θ∈Θ in some parameter space Θ. A pre-trained sequence processing model can be designated by b (for the base or reference model), whose parameters are θ_{b}. For each token value, the model sequentially (in t) can forward propagate to generate a Softmax logit score sₜᵥ^{b}, for the token yₜ taking token value v. The Softmax probability of yₜ taking value v∈V is given by

$${p}_{θ} ( {y}_{t} = v \vert {y}_{< t} ) = \frac{exp ( {s}_{tv}^{h} )}{{\sum }_{{v}^{′} ∈ V} exp ( {s}_{{tv}^{′}}^{b} )} \qquad ( 1 )$$

A fine-tuning setup based on human (or model) preferences has the model generate a sequence y, a pair of sequences {yᵢ, yⱼ}, or a set of sequences, of up to T tokens each, in response to a prompt x. In a pointwise label setting, y is assigned a single preference label z. In the binary setting, z∈{0,1}, where 1 is a favorable/preferred (positive) label, and 0 is an unfavorable/unpreferred (negative) label. In a classic RLHF (and also DPO) pairwise setting, an ordered pair of sequences yᵢ and yⱼ sampled for the same prompt x by the base model are given a pairwise label zᵢⱼ∈{0,1}, where 0 indicates that sequence yⱼ is preferred over yᵢ and 1 indicates the opposite case. To simplify the pairwise notation, some descriptions herein denote y_{w} as the winner (preferred) sequence, and yₗ as the loser (unpreferred) sequence. Example descriptions herein focus on application of the proposed techniques to the two settings: pointwise and pairwise, but the proposed method is also applicable applied to more general settings, including listwise preferences over a list of sequences, and non-binary graded preference labels in the pointwise, pairwise or listwise sense.

A separate reward model, or a reward prediction head of a model, can produce an explicit logit score vector r_{≤t,v}, which is used to predict the probability of a positive preference z=1 predicted for the t-th token taking value yₜ=v, conditioned on the subsequence y_{≤t}. The prediction can then be produced by the Sigmoid function from the logit score

$${p}_{θ} ( z = 1 \vert {y}_{< t} , {y}_{t} = v ) = σ ( {r}_{\leq t , v} ) {=}^{Δ} \frac{1}{1 + exp ( - {r}_{\leq t , v} )} \qquad ( 2 )$$

Although the preference label (whether pointwise or relative) is typically assigned to a complete sequence of tokens, in order to allow inference decoding based on posterior preference conditioned predictions, the single preference label for the sequence can be predicted conditionally on y_{≤t} at every time point for all possible token values for v∈V considered for yₜ (or at least for the top-K possible values). Thus the model can produce this logit score causally for every t.

### Example Direct Posterior Preference Fine-Tuning

The product of the token probability in (1) and the conditional preference probability in (2) forms the joint probability:

$${p}_{θ} ( {y}_{t} = v , z = 1 \vert {y}_{< t} ) = {p}_{θ} ( {y}_{t} = v \vert {y}_{< t} ) \cdot {p}_{θ} ( z = 1 \vert {y}_{< t} , {y}_{t} = v ) \qquad ( 3 )$$

Summing over all tokens v gives p_{θ}(z=1|y_{<t}), that can be used to normalize the joint p_{θ}(yₜ=v, z=1|y_{<t}) to give the posterior p_{θ}(yₜ=v|y_{<t}, z=1). (The conditional p_{θ}(z=1|y_{<t}) also equals the conditional preference probability at the previous token's time point t−1.)

DPPFT, proposed herein, fine-tunes the model to directly generate posterior logit scores sₜᵥ=sₜᵥ^{p}, which can be used directly in decoding as the fine-tuned model scores, replacing equation (3) by

$${p}_{θ} ( {y}_{t} = v \vert {y}_{< t} , z = 1 ) = \frac{exp ( {s}_{tv} )}{{\sum }_{{v}^{′} ∈ V} exp ( {s}_{{tv}^{′}} )} \qquad ( 4 )$$

where sₜᵥ are the Softmax posterior logit outputs of the model.

### Example Direct Posterior Preference Scores

To derive posterior token probabilities, two predictions should be considered per token during fine-tuning over a sequence; of the token taking value yₜ=v, and based on the token prefix y_{≤t} of the full sequence preference label z. Directly computing the posterior logits sₜᵥ=sₜᵥ^{p} does not provide the information of the preference logits r_{≤t,v}. Thus one challenge is how to design low-complexity methods that apply losses that need to directly model the effect of the preference labels z on the preference label prediction scores r_{≤t,v} which are not directly available, specifically with negative preferences, for which the posteriors are not stored. One solution approach is to compute the preference probabilities p_{θ}{z|y_{<t}} on the fly from the posterior scores sₜᵥ and the frozen base model predictions in (1), and apply the preference model losses with the computed probabilities. A second approach applies losses directly on the posterior scores. According to an aspect of the present disclosure, to enable this approach all tokens with a negative prefix preference label can be aggregated (explicitly or implicitly) into a single symbol z≠1, whose probability p_{θ}{z≠1|y_{<t}} is produced only in some implementations of fine-tuning training, but need not be computed during decoding.

While the first approach allows directly applying ranking (pairwise or listwise) losses with relative (pairwise or listwise) preference labels, for the second, a ranking loss cannot be applied directly on the unavailable scores r_{≤t,v}. Two solutions address that; multi-head multi-objective training, and ranking losses directly applied on the posterior scores. The first adds an additional training-only head to the fine-tuning process to directly train a non-deployable preference ranking loss with a single scalar forward and backpropagation. The second directly uses the posterior logits sₜᵥ with an additional ranking objective on the same prediction head. The joint probability interpretation of sₜᵥ can also be extended to the pairwise event describing the next token on both preferred and nonpreferred sequences leading to a pairwise loss.

To understand the relationship between the posterior logit scores and a joint distribution, recall that sₜᵥ are the posterior logit scores for token yₜ taking value v conditioned on z=1. According to an aspect of the present disclosure, the Softmax function has a single degree of freedom which can be assigned to a logit score for p_{θ}{z≠1|y_{<t}}, aggregating all joint probabilities of any token value with a negative preference. For simplicity, we assign logit score of 0 to this probability. This gives

$$\begin{matrix}{p}_{θ} ( {y}_{t} = v , z = 1 \vert {y}_{< t} ) = \frac{exp ( {s}_{tv} )}{1 + {\sum }_{{v}^{′} ∈ V} exp ( {s}_{{tv}^{′}} )} \\ {p}_{θ} ( z \neq 1 \vert {y}_{< t} ) = \frac{1}{1 + {\sum }_{{v}^{′} ∈ V} exp ( {s}_{{tv}^{′}} )} \\ {p}_{θ} ( z = 1 \vert {y}_{< t} ) = \frac{{\sum }_{{v}^{″} ∈ V} exp ( {s}_{{tv}^{″}} )}{1 + {\sum }_{{v}^{′} ∈ V} exp ( {s}_{{tv}^{′}} )}\end{matrix} \qquad ( 5 )$$

Normalizing the first equation in (5) by the third gives the posterior probability in (4). Thus the posterior logits conditioned on z=1 are consistent with the joint logit scores under the model of equation (5) that aggregates all scores with negative preference into a single symbol. For convenience, aggregated Softmax scores can also be defined as follows

$${S}_{t} {=}^{Δ} log {\sum }_{v ∈ V} exp ( {s}_{tv} ) and {U}_{t} {=}^{Δ} log \{ 1 + {\sum }_{v ∈ V} exp ( {s}_{tv} ) \} \qquad ( 6 )$$

The architecture of Equation (5) can be directly implemented by a model that generates M posterior scores sₜᵥ for the t-th token for v∈V. The scores can be used as in equations (4) and (5) to obtain both the posterior of yₜ conditioned on z=1, and the joint distribution over the pair {yₜ, z=1}, and the additional aggregated symbol for z≠1, respectively. With a pointwise loss, training of the fine-tuned model can optimize a cross entropy loss on the joint distribution which includes the aggregated negative preference symbol. If the true preference label is z≠1, then the loss is the negative logarithm of the probability of this symbol, which is expressed in (5) by the logits of all the other {token, z=1} pairs. An example pointwise loss applied to a sequence of tokens is given by

$$L ( y ) = {\sum }_{t = 1}^{T} \{ - z \cdot log {p}_{θ} ( {y}_{t} , z = 1 \vert {y}_{< t} ) - ( 1 - z ) \cdot log {p}_{θ} ( z \neq 1 \vert {y}_{< t} ) \} \qquad ( 7 )$$

If the sequence has a positive preference label z=1, the first term of (7) can be applied to all tokens yₜ, giving negative loss gradients to sₜᵥ that push to increase the Softmax scores of all tokens yₜ present in the sequence, and to decrease the Softmax scores of token values not present in the sequence. With a negative preference label z=0, the second term of the loss is applied for all t, pushing down the Softmax scores of all tokens. Because the gradients are scaled by the exponents of the scores, vocabulary token values with large scores (that are likely to show in a sampled sequence) are pushed down more aggressively. This usually includes sampled token values that have high marginal probabilities by the base model according to the training dataset, but are undesired by the preference model. The optimization in (7) attempts to exclude unpreferred sequences from the Softmax scores optimization, pushing their probabilities to a “do not care” symbol, while keeping only the distribution of tokens over sequences that have a preferred label.

In some implementations, the Softmax scores can be initialized to those of the base model. A low rank architecture that keeps the base model parameters frozen should guarantee such initialization by initializing the fine-tuning only model parameters. Decoding can completely ignore the extra symbol, and can be applied by using the posterior Softmax scores as the fine-tuned scores with equation (4). Model decoding can be applied the same as or similar to RLHF decoding with the posterior predictions.

### Example Fine-Tuning with Implicit Preference Predictions

This section first considers methods that produce the posterior logit scores sₜᵥ in training for decoding, but during fine-tuning revert back to the conditional preference predictions in equation (2) in order to apply pointwise and/or ranking losses directly on these predictions.

A direct implementation of a posterior preference optimization explicitly fine-tunes the predictions of the posterior scores sₜᵥ. With the top equation of (5), these can give the joint probability p_{θ}(yₜ=v, z=1|y_{<t}). Equation (3) can then be used to obtain the preference probability p_{θ}{z=1|y_{≤t}} provided we have the base model logits sₜᵥ^{b} to produce the marginal in (1). Then, the preference labels can be used based on the labels z for supervised fine-tuning.

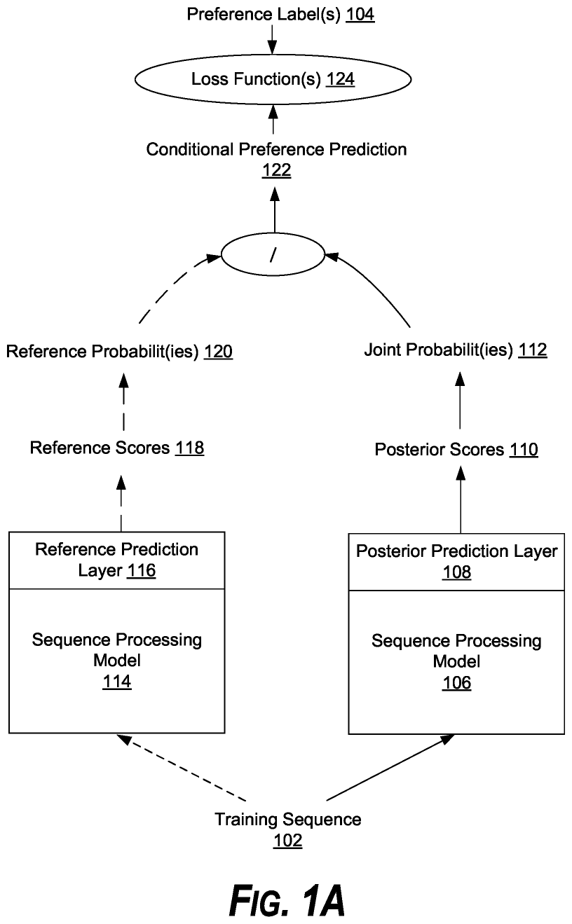

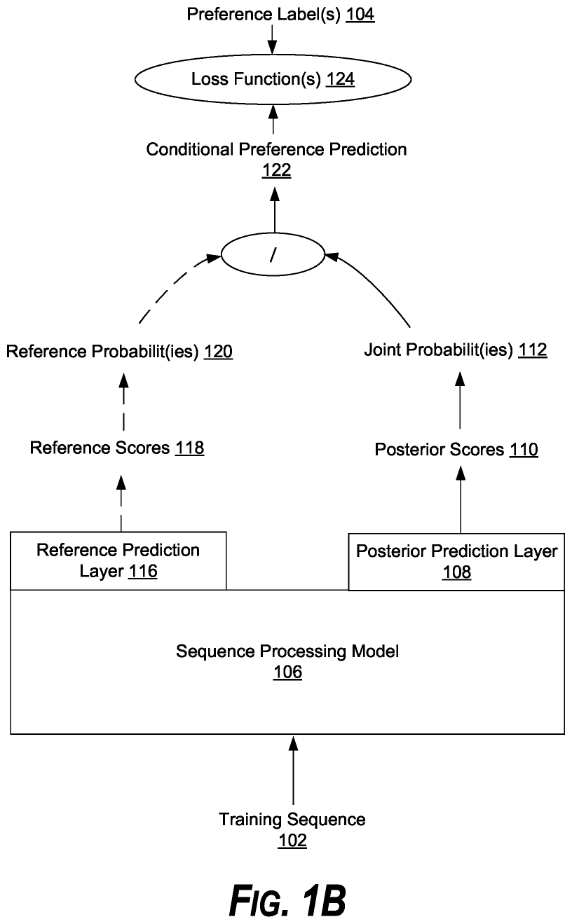

FIGS. 1A-C show example implementations of this approach. Specifically, FIGS. 1A-C shows example implementations of a direct posterior preference fine-tuning approach for a single token in a sequence which leverages the predictions of the base model to apply fine-tuning with implicit preference predictions and preference label losses. In the Figures of the present disclosure, unless it is clearly otherwise from the text, solid lines represent paths of both forward and backward propagation of information while dashed lines indicate paths of forward propagation only. Note, however, that the forward/backward indications provided by line type are examples only and that other variations or approaches can be used in addition to the illustrated examples. Where a drawing component includes a variable or value in brackets, the variable or value indicates a dimensionality of data present at the drawing component.

Referring first to FIG. 1A, a training tuple includes a training sequence 102 and a preference label 104. A sequence processing model 106 processes at least a portion of the sequence of tokens in the training sequence 102 to generate, as an output of a posterior prediction layer 108 of the sequence processing model 106, a plurality of posterior scores 110 respectively for a plurality of candidate token values included in a token vocabulary. The plurality of posterior scores 110 are conditioned on the preference label 104 being a positive label (irrespective of the actual, true value of the preference label 104).

In some cases, the posterior scores 110 can be unnormalized values which can then be normalized (e.g., using a Softmax function) to generate probability value(s) for candidate tokens. In that sense, the posterior scores 110 can in some cases be referred to as “logit scores.” More generally, the posterior scores 110 can represent the values produced by the posterior prediction layer 108 of the sequence processing model 106, which may be a “final” output layer or which may be a “hidden” layer that is followed by other layer(s). In that sense, the posterior scores 110 may also be referred to in some cases as “embeddings” or “latent features” for which there is a function that defines a correspondence between scores and probabilities of respective candidate tokens.

A joint probability 112 can be determined for at least the actual fine-tuning training sequence token value of the plurality of candidate token values based on the plurality of posterior scores 110. For example, the actual token value can be the actual next token in the training sequence 102. The joint probability 112 indicates the predicted joint probability of both of the following events: the token value being the next sequential token in the training sequence 102 and the preference label 104 being a positive label. According to an aspect of the present disclosure, determining the joint probability 112 can include either explicitly or implicitly aggregating all joint probabilities of the candidate token values and the preference label being a negative label to an additional aggregated symbol.

Furthermore, in the example implementation illustrated in FIG. 1A, at least the portion of the sequence of tokens in the training sequence 102 is also processed by a different sequence processing model 114 (e.g., a “base” or “reference” model) to generate, as an output of a reference prediction layer 116, a plurality of reference scores 118 respectively for the plurality of candidate token values included in the token vocabulary. For example, the sequence processing model 114 can be a pre-trained checkpoint. For example, the sequence processing model 106 can be instantiated from the sequence processing model 114 and then finetuned as illustrated.

A reference probability 120 can be determined for at least the actual token value based on the plurality of reference scores 118. The reference probability 120 can indicate a predicted probability of such token being the next sequential token in the training sequence 102, without consideration of whether or not such token would be preferred.

A conditional preference prediction 122 can be determined based on the joint probability 112 and the reference probability 120. A loss function 124 can generate a loss value based on the conditional preference prediction 122 and the preference label 104. For example, the loss function 124 can be any of the different loss functions described herein which operate on conditional preference predictions.

In some implementations, the preference label 104 can include multiple preference labels 104. For example, for a particular training tuple, both a pointwise preference label and a pairwise “ranking” label may be present. In some implementations, the loss function 124 can include multiple loss functions 124. For example, when both a pointwise preference label and a pairwise “ranking” label are present, the loss functions 124 can include both a pointwise loss (e.g., binary cross entropy loss) and a pairwise loss (e.g., binary pairwise ranking loss).

One or more values of one or more parameters of the sequence processing model 106 can be modified based on the loss function 124. For example, the loss function 124 can be backpropagated to update the value(s) of parameter(s) of the model 106. Some of all of the parameters of the model 106 can be updated. For example, in some implementations, only the posterior prediction layer 108 is updated. In other implementations, other subsets of the model parameters can be modified or held fixed, as described elsewhere herein.

After training, the sequence processing model 106 can be deployed for inference. During inference, the posterior scores 110 can be used to generate a servable posterior that models the probability of the next token conditioned on both the preference label being positive and the preceding tokens. For example, during inference, the posterior scores 110 output by the posterior prediction layer 108 of the sequence processing model 106 can be used to directly model a posterior probability of the candidate token values given an input prompt and the prefix of the decoded sequence up to the current token value. Therefore, when generating an output during inference, output tokens can be sampled according to the posterior probability generated from the posterior scores 110. This aspect regarding deployment of the posterior scores 110 to generate a servable posterior applies to all implementations of the present disclosure.

FIG. 1B shows a similar approach to FIG. 1A, with the exception that, in FIG. 1B, there is a single sequence processing model 106 which has multiple output layers or “heads”, including both the posterior prediction layer 108 and the reference prediction layer 116. In these implementations, the two layers 108 and 116 can share a backbone, thereby reducing computational costs. FIG. 1C shows yet another approach similar to FIG. 1A, with the exception that, in FIG. 1C, the reference scores 118 and/or probabilities 120 are simply accessed from a computer-readable storage device 130. For example, this approach can be applied where the reference scores and/or probabilities 120 have been pre-computed by the reference model and then stored. In some cases, the storage device 130 may therefore be referred to as a “replay buffer”.

Thus, collectively to FIGS. 1A-C, instead of producing binary logits for the preference label 104, the posterior prediction layer 108 can produce M posterior Softmax logit scores 110, which can be converted to joint probability 112 by (5). Rearranging (3), the joint predictions 112 can be divided by the reference predictions 120 to give the conditional preference prediction 122 of the binary preference label as follows:

$${p}_{θ} ( z = 1 \vert {y}_{< t} {y}_{t} = v ) = \frac{{p}_{θ} ( {y}_{t} = v , z = 1 \vert {y}_{< t} )}{{p}_{θ} ( {y}_{t} = v \vert {y}_{< t} )} \qquad ( 8 )$$

Equation (8) can be converted by the inverse of the Sigmoid to preference scores r_{≤t,v},

$$\begin{matrix}{r}_{\leq t , v} {=}^{Δ} log {p}_{θ} ( z = 1 \vert {y}_{< t} , {y}_{t} = v ) - log {p}_{θ} ( z \neq 1 \vert {y}_{< t} , {y}_{t} = v ) \\ = log \frac{{p}_{θ} ( z = 1 \vert {y}_{< t} , {y}_{t} = v )}{{p}_{θ} ( {y}_{t} = v \vert {y}_{< t} ) - {p}_{θ} ( {y}_{t} = v , z = 1 \vert {y}_{< t} )}\end{matrix} \qquad ( 9 )$$

where p_{θ}(z≠1|y_{<t}, yₜ=v)=1−p_{θ}(z=1|y_{<t}, yₜ=v).

Pointwise and/or ranking losses relative to true preference labels (e.g., preference label 104) can be applied to the preference predictions.

At inference time, decoding only requires the sequence processing model 106 (including the posterior prediction layer 108) to produce the posterior scores 110 (e.g., up to the generation of the joint prediction).

Referring again to training time, because, in some implementations, optimization is applied only to the joint/posterior scores (sₜᵥ), which constitute only the numerators of (8) and of the second equality in (9), some example implementations either clip or regularize such losses with additional terms that can guarantee that the joint probabilities p_{θ}(yₜ=v, z=1|y_{<t}) never exceed the marginal priors p_{θ}(yₜ=v|y_{<t}). This is discussed in further detail below.

An example pointwise per-sequence loss with a per-sequence preference label z is given by

$$\begin{matrix}L ( y ) = {\sum }_{t = 1}^{T} \{ z \cdot log [ 1 + exp ( - {r}_{\leq t , {y}_{t}} ) ] + ( 1 - z ) \cdot log [ 1 + exp ( {r}_{\leq t , {y}_{t}} ) ] \} \\ = {\sum }_{t = 1}^{T} \{ - z \cdot log \frac{{p}_{θ} ( {y}_{t} , z = 1 \vert {y}_{< t} )}{{p}_{θ} ( {y}_{t} \vert {y}_{< t} )} - ( 1 - z ) \cdot log \frac{{p}_{θ} ( {y}_{t} \vert {y}_{< t} ) - {p}_{θ} ( {y}_{i} , z = 1 \vert {y}_{< t} )}{{p}_{θ} ( {y}_{t} \vert {y}_{< t} )} \}\end{matrix} \qquad ( 10 )$$

This loss can be applied over multiple sequences.

The effect of the preference model can be enhanced by scaling the logits r_{≤t,y}_{ₜ} by β<1, which would force the learned logit and its respective preference probability to be larger, pushing the fine-tuned model farther away from the reference model for tokens in a preferred sequence.

The gradient of the loss in (10) relative to the posterior logit score of the observed token is given by

$$\frac{\partial L ( y )}{\partial {s}_{{t}_{{y}_{t}}}} = - z \cdot \{ 1 - {p}_{θ} ( {y}_{t} , z = 1 \vert {y}_{< t} ) \} + ( 1 - z ) \cdot \frac{{p}_{θ} ( {y}_{t} , z = 1 \vert {y}_{< t} ) \cdot [ 1 - {p}_{θ} ( {y}_{t} , z = 1 \vert {y}_{< t} ) ]}{{p}_{θ} ( {y}_{t} \vert {y}_{< t} ) - {p}_{θ} ( {y}_{t} , z = 1 \vert {y}_{< t} )}$$

Its gradient relative to logit scores of other tokens is

$$\frac{\partial L ( y )}{\partial {s}_{tw ; w \neq {y}_{t}}} = z \cdot {p}_{θ} ( w , z = 1 \vert {y}_{< t} ) - ( 1 - z ) \cdot \frac{{p}_{θ} ( {y}_{t} , z = 1 \vert {y}_{< t} ) \cdot {p}_{θ} ( w , z = 1 \vert {y}_{< t} )}{{p}_{θ} ( {y}_{t} \vert {y}_{< t} ) - {p}_{θ} ( {y}_{t} , z = 1 \vert {y}_{< t} )}$$

Let y_{w}, yₗ be preferred and unpreferred sequences, respectively, according to a human pairwise preference. Assume that the label of one sequence uniquely determines that of the other. Then

$${p}_{θ} ( {z}_{w} = 1 \vert {y}_{w , < i} , {y}_{wt} = v ) = {p}_{θ} ( {z}_{l} \neq 1 \vert {y}_{l , < t} , {y}_{lt} = u ) \qquad ( 11 )$$

where the t-th token of the preferred sequence is v, and that of the unpreferred one is u. From (11), the pairwise log odds score for the prefix of y_{w} up to the t-th token y_{wt}=v being preferred over the respective prefix of yₗ up to the t-th token yₗₜ=u is given by

$$\begin{matrix}{r}_{wl , \leq t} {=}^{Δ} {r}_{wl , \leq t} ( {y}_{wt} = v , {y}_{lt} = u ) = log \frac{{p}_{θ} ( {z}_{w} = 1 \vert {y}_{w , < t} , {y}_{wt} = v )}{{p}_{θ} ( {z}_{l} = 1 \vert {y}_{l , < t} , {y}_{lt} = u )} \\ = log \frac{{p}_{θ} ( {y}_{wt} = v , {z}_{w} = 1 \vert {y}_{w , < t} )}{{p}_{θ} ( {y}_{wt} = v \vert {y}_{w , < t} )} - log \frac{{p}_{θ} ( {y}_{lt} = u , {z}_{l} = 1 \vert {y}_{l , < t} )}{{p}_{θ} ( {y}_{lt} = u \vert {y}_{l , < t} )}\end{matrix} \qquad ( 12 )$$

Applying the Sigmoid function on (12) and taking the negative logarithm gives an example pairwise loss as follows:

$$\begin{matrix}{L}_{R} ( {y}_{w} , {y}_{l} ) = {\sum }_{t = 1}^{T} log \{ 1 + exp [ - ( log \frac{{p}_{θ} ( {y}_{wt} , {z}_{w} = 1 \vert {y}_{w , < t} )}{{p}_{θ} ( {y}_{wt} \vert {y}_{w , < t} )} - log \frac{{p}_{θ} ( {y}_{lt} , {z}_{l} = 1 \vert {y}_{l , < t} )}{{p}_{θ} ( {y}_{lt} \vert {y}_{l , < t} )} ) ] \} \\ = - log \frac{{p}_{θ} ( {y}_{wt} , {z}_{w} = 1 \vert {y}_{w , < t} ) \cdot {p}_{θ} ( {y}_{lt} \vert {y}_{l , < t} )}{{p}_{θ} ( {y}_{wt} , {z}_{w} = 1 \vert {y}_{w , < t} ) \cdot {p}_{θ} ( {y}_{lt} \vert {y}_{l , < t} ) + {p}_{θ} ( {y}_{lt} , {z}_{l} = 1 \vert {y}_{l , < t} ) \cdot {p}_{θ} ( {y}_{wt} \vert {y}_{w , < t} )}\end{matrix} \qquad ( 13 )$$

Equation (12) is derived under the assumption in (11) that the preference between the two sequences y_{w} and yₗ is exclusive (if z_{w}=1, then zₗ=0, and vice versa), implying that one sequence must be preferred over the other. Pairwise labeling in which a sequence is always preferred satisfies this assumption. However, such an assumption is not aligned with per-sequence decoding, which implicitly assumes a preference probability mass to every possible sequence (independently of other sequences). The preferences learned from the loss in (13) allow giving two sequences simultaneously positive or negative preference, yet, do not model such a case in the loss. A temperature hyperparameter β on the score r_{wl,≤t} can absorb such model misspecification. Applying β to the score in (12) gives an example parameterized form of (13)

$$\begin{matrix}{L}_{R} ( {y}_{w} , {y}_{l} ) = {\sum }_{t = 1}^{T} log \{ 1 + exp [ - β \cdot ( log \frac{{p}_{θ} ( {y}_{wt} , {z}_{w} = 1 \vert {y}_{w , < t} )}{{p}_{θ} ( {y}_{wt} \vert {y}_{w , < t} )} - log \frac{{p}_{θ} ( {y}_{lt} , {z}_{l} = 1 \vert {y}_{l , < t} )}{{p}_{θ} ( {y}_{lt} \vert {y}_{l , < t} )} ) ] \} \\ = - log \frac{{[ {p}_{θ} ( {y}_{wt} , {z}_{w} = 1 \vert {y}_{w , < t} ) \cdot {p}_{θ} ( {y}_{lt} \vert {y}_{l , < t} ) ]}^{β}}{{[ {p}_{θ} ( {y}_{wt} , {z}_{w} = 1 \vert {y}_{w , < t} ) \cdot {p}_{θ} ( {y}_{lt} \vert {y}_{l , < t} ) ]}^{β} + {[ {p}_{θ} ( {y}_{lt} , {z}_{l} = 1 \vert {y}_{l , < t} ) \cdot {p}_{θ} ( {y}_{wt} \vert {y}_{w , < t} ) ]}^{β}}\end{matrix} \qquad ( 14 )$$

While one role of is to fix the misalignment described, a primary role (as described following (10)) is to balance between the preference model and the marginal prior reference model, specifically, pushing more weight to the preference model. This is beneficial in cases where the reference model may not capture sequences that are preferred for the specific alignment task. The hyperparameter β<1 enhances the ratio between preference probabilities of preferred and non preferred sequence, essentially giving more weight to the preference model.

The pointwise loss in (10) calibrates the pairwise losses in (13)-(14). Similar concepts in the derivations of (13)-(14) can be used with listwise losses and with nonbinary preference labels.

For the losses in (13)-(14), numerators inside the internal logarithms of the first equations are target distribution predictions and denominators are reference pre-trained model predictions. The losses in (13)-(14) can be applied on a per-token incremental basis on all T sequence prefixes (e.g., instead of being applied as a single loss for the full sequence). Applying the loss for each prefix directly optimizes the decoding target, and thus seems more suitable to actual (per-token) decoding. It can gather similar prefixes of multiple sequences that together have high preference. This can result in faster training.

The approach leading to (13)-(14) considers the joint token/preference events {y_{wt}, z_{w}} and {yₗₜ, zₗ}(conditioned on both prefixes y_{w,<t} and y_{l,<t}) as mutually exclusive pairwise events, where zₗ=1−z_{w}. In decoding, (done per sequence and not per pairs,) no such assumption is possible. Additionally, even in fine-tuning, sequence y_{w}, for example, can be paired with sequences other than yₗ in different pairwise training examples. It may be reasonable to assume that these event pairs may not be mutually exclusive (specifically, because single sequence decoding is not aligned with such an assumption). With a hyperparameter β designed to correct for misspecification, an independence assumption between the pair probabilities leads to directly using the two individual log odds ratios r_{w,≤t,y}_{_{wt}} and r_{l,≤t,y}_{ₗₜ}, as defined in (9), for the following example pairwise loss

$${L}_{R} ( {y}_{w} , {y}_{l} ) = {\sum }_{t = 1}^{T} log \{ 1 + exp [ β \cdot ( {r}_{l , \leq t , {y}_{lt}} - {r}_{w , \leq t , {y}_{wt}} ) ] \} \qquad ( 15 )$$

The losses in (14) and (15) can be compared through the joint preference probabilities for both prefixes, implying that we expect a smaller value of f in (15) than (14). In the case of mutually exclusive events (11), the argument of the Sigmoid of (15) is double that of (14). Because both arguments seem to overestimate the argument of a single sequence decoding model, we expect β<1 in both cases for proper compensation to this misspecification. To mix the assumptions leading to (13)-(14) and (15), a convex combination of the losses can in some implementations be applied, with some hyperparameter ξ, 0<ξ<1, that weighs between the two.

An alternative to the example pairwise losses in (13)-(15) is a loss that is consistent with a per-sequence preference distribution. One approach is to ask labelers to score a third label, which indicates that neither of the sequences is preferred, in addition to labels of one being preferred over the other. Equation (15) can then be applied only on pairs for which there is a specific preference, while dropping pairs for which no preference has been selected. With this, the pairwise ranking loss matches per sequence preference probabilities by matching the conditional probability that one sequence is preferred over the other conditioned on the event that there is such preference. Without changing the labeling strategy, we can make an assumption similar to that in Burges et al., Learning to Rank using Gradient Descent, ICML (2005) (“RankNet”), where a no-preference is mapped to either of the preference categories with equal probability. In the Ranknet paper, such an assumption is made on the label. Instead, some implementations of the present disclosure can map a per-sequence preference model to match the given labels by training the model towards an expected preference label, taking into account the events where the model has tied preferences. This gives an example pairwise ranking loss of (16)

$${L}_{R} ( {y}_{w} , {y}_{l} ) = - {\sum }_{t = 1}^{T} log \{ \frac{1}{2} \cdot [ 1 + \frac{{p}_{θ} ( {y}_{wt} , {z}_{w} = 1 \vert {y}_{w , < t} )}{{p}_{θ} ( {y}_{wt} \vert {y}_{w , < t} )} - \frac{{p}_{θ} ( {y}_{lt} , {z}_{l} = 1 \vert {y}_{l , < t} )}{{p}_{θ} ( {y}_{lt} \vert {y}_{l , < t} )} ] \} \qquad ( 16 )$$

where the two probability terms are the implicit preference probabilities of the preferred and non-preferred sequences predicted by the respective prefixes, and derived as ratios between the joint prefix/preference probabilities and the marginal reference model probabilities. The term inside the logarithm gives the expected preference probability of y_{w} over yₗ by the model described. The ½ term inside the logarithm can be dropped, but this description keeps it to illustrate that the argument is a probability.

A parameter β<1 can also be applied in (16) to enhance the preference model effect, by exponentiating each ratio inside the logarithm by β.

Fine-tuning with this overall methodology can apply a pointwise loss (e.g., (10)), a pairwise loss (e.g., (13)-(16)), or a combination of the two losses. A hyperparameter a can weigh between (10) and (13)-(16) (and/or other loss functions) to balance the objectives, in cases that multiple loss functions are used.

The losses of (10), and (13)-(16) do not guarantee that p_{θ}(yₜ=v, z=1|y_{<t}) p_{θ}(yₜ=v|y_{<t}). If the training system explicitly optimizes the scores r_{≤t,v} of (9), this is guaranteed because the preference logit score is the one optimized. However, (10), (13)-(16) optimize the joint/posterior scores sₜᵥ. Expected solutions may guarantee ρ≡p_{θ}(yₜ=v, z=1|y_{<t})/p_{θ}(yₜ=v y_{<t})≤1. However, there is no such guarantee for individual solutions. Equations (13)-(14) may exacerbate this by optimizing a ratio of two potentially independent ρ ratios. To give the model more flexibility to capture a more generalized posterior, it may not be necessary to force the constraint. To ensure that the optimization does not violate the constraint ρ≤1, some example implementations can optionally add a barrier function −log(1−ρ) to the loss, to force this ratio not to exceed 1. Such a regularizer can be added with a small scaling factor v<1. Alternatively, p can be clipped to 1−ε when applying the division shown in FIGS. 1A-C and elsewhere. Finally, some example implementations can express the joint as a product between the posterior and the partition function in the third equality of (5), and stop gradient propagation to the partition function. This way the training system can directly optimize the posterior that is not bounded like the joint.

Because of the per-token losses, preference score gradients for token t may propagate to the parameters τ at for τ<t. In a batch setting, updates to all tokens in a sequence may be applied at once. Thus the preference parameters of token r may receive T−τ+1 updates at once. The model may distribute credit internally to adjust to such updates. However, not propagating preference gradients to previous tokens by applying stop-gradients may mitigate this concern.

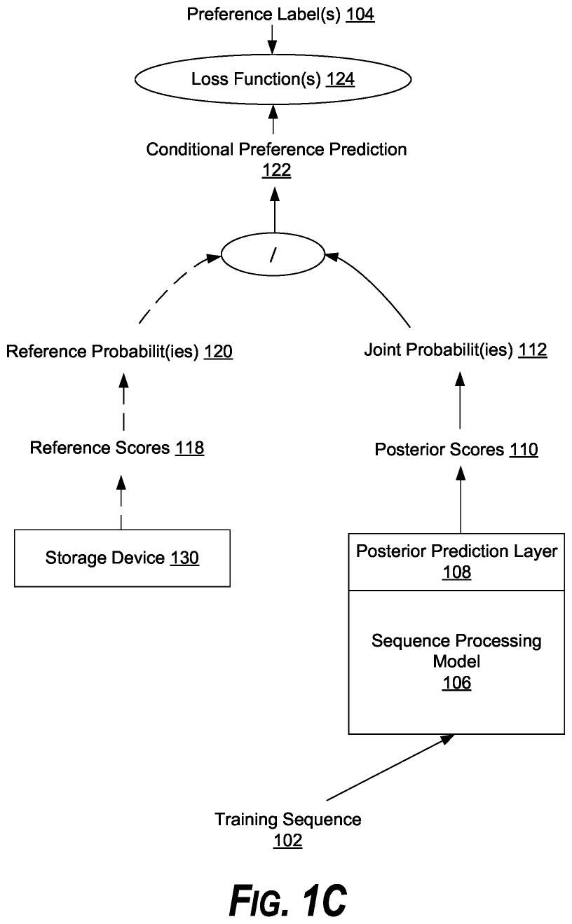

Referring still to FIGS. 1A-C, in some implementations, the fine-tuned component of the sequence processing model 106 may consist of all model parameters of the model 106. In some implementations, the training system can freeze the parameters of the reference sequence processing model 114. In some implementations, the training system can apply different architectures that consist of small subset(s) of parameter(s) of the sequence processing model 106 that update during fine-tuning (e.g., while other portion(s) of the model 106 are held fixed). (Gradients can also be applied only to parameters of the current token.) Some examples of these more limited fine-tuning approaches include applying LoRA on different layers of the model 106, applying a Gated LOw Rank Inference (GLORI) approach as described in further detail below with respect to FIG. 2 and elsewhere, or other approaches.

As an example, FIG. 2 illustrates direct posterior preference gated low-rank fine tuning with joint and base model token and preference probability predictions. In particular, the GLORI approach illustrated in FIG. 2 can take the d-dimensional top linear layer 206 of the sequence processing model 106 (e.g., shown here as a transformer), and through a low rank bottleneck produces two new d-dimensional layers, A and B.

Layer A goes through a gating function 204 that can take various forms such as, for example, a Sigmoid as illustrated in FIG. 2. The units of the gate output multiply the top layer 206 of the model 106 (e.g., a Transformer), and then add layer B to the output. With the Sigmoid gate 204, to ensure initialization of the fine-tuned output to the output of the pre-trained model, the top layer weights producing A and B can be initialized to 0, and the gate can be multiplied by 2.

A top weight matrix 202 of the reference model can be frozen and applied to produce both the reference scores 118 and the posterior scores 110. Decoding inference can be applied with only the right-side components of the model which produce the posterior scores 110.

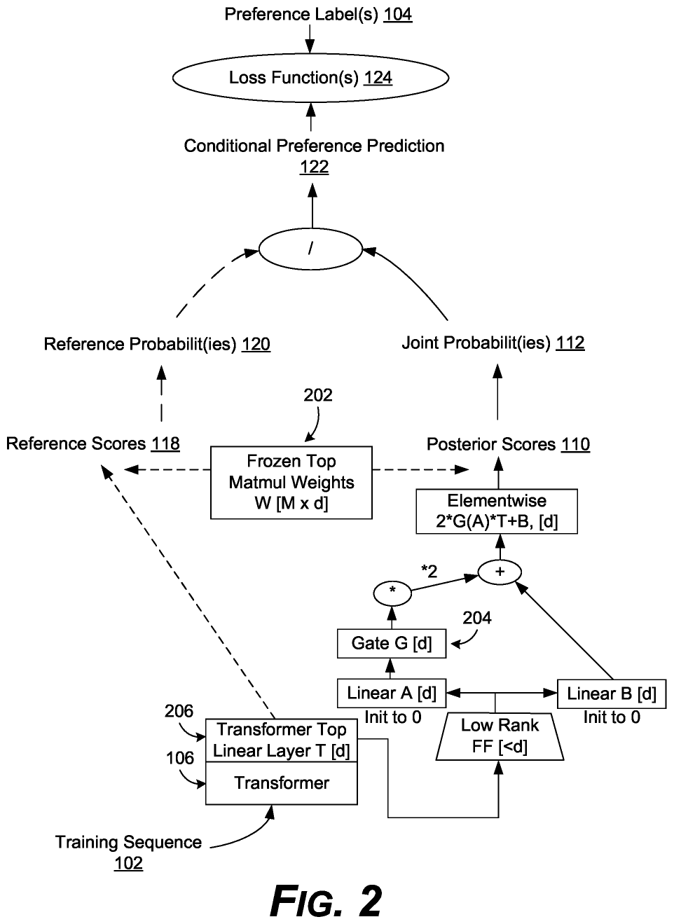

Some example implementations can omit either layer A or layer B to still have a low-rank fine-tuning, where omitting A gives an approach like LoRA, except that it uses the same base layer for the input and output. Further, while FIG. 2 illustrates the GLORI approach used in an example implementation that leverages reference scores 118 to generate the conditional preference prediction 122, the GLORI approach can also be applied in any of the other implementations described herein, such as those illustrated in FIGS. 3, 5, and 6.

### Example Fine-Tuning with Posterior Scores

### Example Pointwise with Posterior, Pairwise with Implicit Preference

For a pointwise loss, some example implementations can use the joint distribution defined in (5). However, there is no explicit ranking of pairs {v, z}. Thus some example implementations can store the posterior logit scores and use them to directly train a pointwise joint probability loss (7), but use the prior base model predictions to extract preference label predictions to additionally apply a pairwise (or other) ranking loss using any of (13)-(16). Again, some hyperparameter a can balance between the two losses.

Using the approach in FIG. 2 still requires forward propagation computation of all M (or at least top-K) reference scores that are needed to compute the marginal reference probabilities in (1). To avoid this computation some example implementations can train a prediction head from the fine-tuned model that predicts the Softmax normalizer score Sₜ^{b} (e.g., as defined in (6)) of the reference model prediction. This prediction can be pre-trained or trained during fine-tuning against the logarithm of the sum of the reference model exponentiated Softmax scores, with losses such as a square loss. Then, this predicted normalizer score can be used to produce the reference model probabilities in equation (1), which are then used to derive the conditional preference prediction during fine-tuning. One example of this approach is illustrated in FIG. 3.

FIG. 3 illustrates a direct posterior preference fine-tuning with joint probability pointwise fine-tuning aggregating p_{θ}(z≠1|y_{<t}) as one symbol, implicit preference probability pairwise ranking fine-tuning, and with fine-tuned prediction of a Softmax base prediction normalizer.

In particular, referring to FIG. 3, the example sequence processing model 106 illustrated in FIG. 3 can be configured to generate a normalizer score 304 as an output of a normalization prediction layer 302 of the sequence processing model 106. The training system can determine the reference probability(ies) 120 for some subset of the plurality of candidate token values based on the reference scores 118 and the normalizer score 304. As in prior approaches, the training system can determine the conditional preference prediction 122 based on the joint probability(ies) 112 and the reference probabilit(ies) 120.

As illustrated in FIG. 3, a binary pairwise ranking loss 324 can compare the conditional preference prediction 122 to a sequence ranking label 326. For example, the sequence ranking label 326 can be a pairwise ranking label that indicates a preference between the training sequence 102 and at least one additional, paired training sequence.

In addition, as illustrated in FIG. 3, in addition to the joint probabilities 112, the training system can determine a negative preference probability 330 from the posterior scores 110. For example, the negative preference probability 330 can be the result of an explicit aggregation of all joint probabilities of the candidate token values and the preference label being a negative label to an additional aggregated symbol. For example, the negative preference probability 330 can be represented as p_{θ}(z=0|y_{<t}) or p_{θ}(z≠1|y_{<t}).

A multilabel cross entropy loss 334 can be evaluated based on the joint probabilities 112, the negative preference probability 330 and a joint label 336. For example, the joint label can include values for yₜ and z.

The approaches illustrated in FIGS. 2 and 3 include computation of the conditional preference prediction 122. On one hand, this imposes an extra complexity for either storing or performing computation of the reference probabilities 120. On the other hand, this type of approach allows using both pointwise and ranking losses to train the posterior prediction layer 108 that produces the posterior logit scores 110. Training the posterior prediction layer 108 using the ranking loss may lead to better ranking performance when the posterior prediction layer 108 is used for decoding.

Directly training the posterior logit scores 110 with a pointwise loss (e.g., (7)) is simple with the joint distribution defined in (5). However, one challenge arises when training with relative (ranking) labels, such as pairwise labels. Example implementations described so far can store the posterior scores 110, but then, using the “prior” reference scores 118 or reference probabilities 120 (which have to be accessible), derive the preference predictions 122 from the posterior scores 110. Other implementations, described in detail below, apply alternative solutions for ranking losses in multi-objective training consisting of pointwise and ranking losses which require neither storage of the reference model parameters nor computation of the reference model scores or probabilities.

### Example Multi-Head Ranking

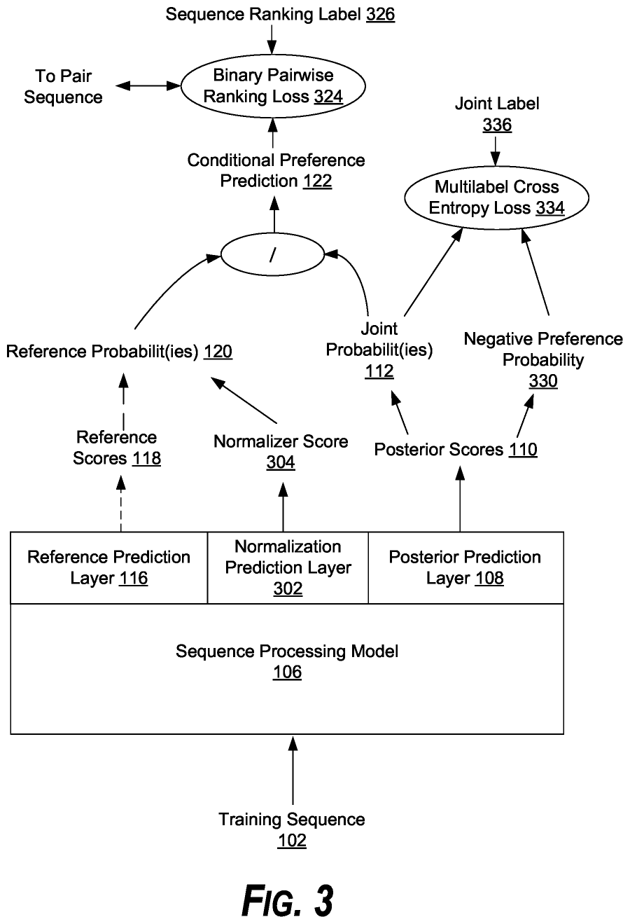

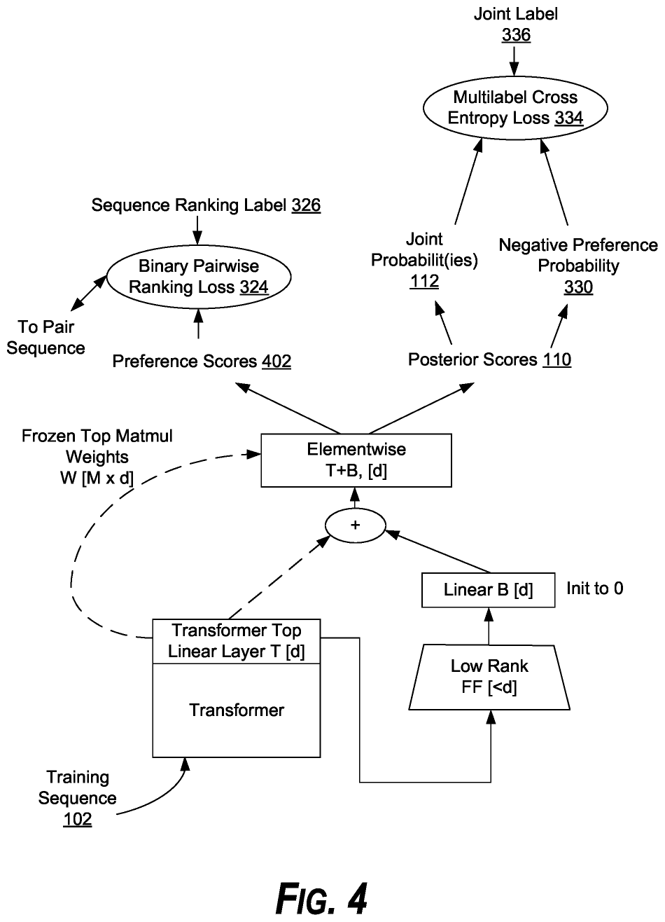

FIGS. 4 and 5 demonstrate a multi-head multi-objective diagram for DPPFT, with LoRA tuning illustrated in FIG. 4 and with a gated tuning illustrated in FIG. 5, respectively. The left branch of the model produces M preference scores 402 (e.g., which may correspond to r_{≤t,v}). A ranking loss 324, such as the pairwise loss in (15), can be applied to the posterior scores 402, for example instead of applying the ranking loss 324 to the posterior scores 110. Thus, the sequence processing model can be said to include a preference prediction layer that generates the preference scores 402.

Losses like (13), (14), or (16) can optionally be applied as the loss 324 by converting the preference scores 402 to probabilities using (2) first and then using the actual preference probabilities instead of the probability ratios. The choice of the loss and the hyperparameter β follows the same comments following (13). The ranking loss 324 can drive the model towards a better relative preference performance in this multi-head setting, pushing the scores of the preferred sequence up, and those of the unpreferred one down. These can be propagated to the same low-rank fine-tuning network (and/or other model parameters) that also produces the posterior scores 110, resulting in the posterior scores 110 also better aligning with the preference rankings.

Because (13)-(16) are functions only of y_{wt} and yₗₜ independent of any other values v∈V, fine-tuning need only propagate scalar predictions of the preference z conditioned only on the actual sampled tokens y_{Wt} and yₗₜ for the preferred and nonpreferred sequences, respectively, minimizing the complexity of a ranking fine-tuning loss. Again, gradients can optionally be propagated only within the per-token parameters. Decoding does not require the preference prediction layer, thus this component can be omitted from deployment.

In the example illustrations of FIGS. 4 and 5, the low rank set of fine-tuning parameters is initialized such that the posterior scores 110 initially take the values of the base, reference, model scores. The right branch produces the posterior scores 110 with the loss in (7), and the left branch, the preference scores 402 or probabilities with a pairwise ranking loss like (13)-(16) (but directly on the preference scores 402). Different ranking losses or nonbinary graded labels can also be used for this component. Again, losses can be balanced by some parameter α. FIG. 4 uses a LoRA fine-tuning set of parameters applied to the top transformer layer, and FIG. 5 uses a low-rank gate with an additive component.

Because the preference objective is trained separately, the misspecification of pairwise losses such as (13)-(14) can be handled differently from (15) with labeling changes or (16). Instead of training the ranking head on predictions that are functions of pointwise token predictions, some example implementations can optimize a cross entropy loss directly on p_{θ}(z_{w}>zₗ|y_{w,≤t}, y_{l,≤t}). Instead of forward propagating a single preference logit score for each of the t-th token values y_{wt} and yₗₜ for both y_{w} and yₗ, respectively, to the left branch in FIGS. 4-5, some example implementations can propagate an embedding vector for each. The concatenation of the embedding vectors for the preferred and nonpreferred sequence can then be used to produce a single logit score with a learned vector of coefficients, where embeddings for the preferred sequence are added as is, while those of the nonpreferred sequence are first negated. The logit score can be converted to p_{θ}(z_{w}>zₗ|y_{w,≤t}, y_{l,≤t}) with the Sigmoid function. An example ranking loss can then be given by

$${L}_{R} ( {y}_{w} , {y}_{l} ) = - {\sum }_{t = 1}^{T} log {p}_{θ} ( {z}_{w} > {z}_{l} \vert {y}_{w , \leq t} , {y}_{l , \leq t} ) \qquad ( 17 )$$

The loss in (17) gives more flexibility to a direct pairwise preference model that can affect the pointwise generation model as a fine-tuning training loss, but without actually interfering with per-sequence generation. Because training only processes a single token value per sequence at any time, a single embedding vector can be shared for all vocabulary token values, and keyed by the actual token value present in the fine-tuning sequence.

Thus, FIG. 4 illustrates multi-head and multi-objective direct posterior preference fine-tuning (DPPFT) with LoRA low rank adaptation. The right branch of the model produces posterior scores 110 sₜᵥ with a joint probability pointwise fine-tuning loss (7) which aggregates all tokens with a negative preference into a single symbol. The left branch produces the preference scores 402 r_{≤t,y}_{ₜ} that are used for pairwise (or other) ranking losses against other sequences.

Similarly, FIG. 5 illustrates multi-head and multi-objective direct posterior preference fine-tuning (DPPFT) with gated low-rank (GLORI) fine-tuning. The model is similar to that in FIG. 4, except the architecture of the fine-tuning parameter set, which is identical to that shown in FIG. 2.

### Example Ranking Directly with Posterior Scores

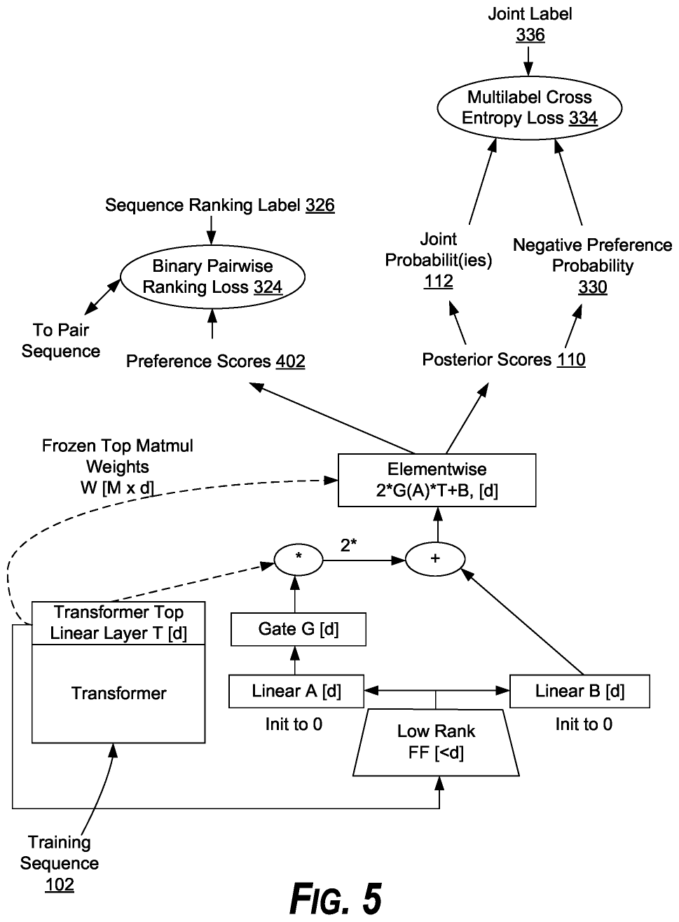

While the example multi-head implementations described above reduce the complexity of computing by eliminating the need for the predictions of the reference model, the multi-head method still adds some minimal complexity to fine-tuning. Training complexity is minimal as the model propagates a single scalar per token as the preference scores 402. However, example implementations do need to store a weight matrix of dimensions M×d (where d is the dimension of the top layer, and the vocabulary can be rather large) that allows propagation of the preference scores 402 r_{≤t,v} for all vocabulary token values. In some instances, this weight matrix can be referred to as the preference prediction layer. The preference prediction layer used for ranking the preference scores 402 does influence the posterior prediction layer used to generate the posterior scores 110. However, in some cases it was observed that applying the ranking loss directly on the posterior prediction layer tends to push the model to better ranking performance with the posterior prediction layer at deployment. In view of this observation, FIG. 6 illustrates an approach for single head direct posterior preference fine-tuning (DPPFT).

In particular, as illustrated in FIG. 6, the sequence processing model produces posterior scores 110 sₜᵥ which are used (e.g., via application of (5)) to generate joint token/preference probabilities 112 and 330 for a pointwise loss (e.g., (7)), but also to generate pairwise scores for a pairwise ranking loss 324 relative to tokens of another sequence. Although not illustrated as such in FIG. 6, the architecture of the fine-tuned parameters can include a LORA implementation as shown in FIG. 4 or a GLORI implementation as shown in FIGS. 4 and 5.

More particularly, applying a ranking loss (e.g., 324) on joint token/preference scores is not trivial, because while there is a natural ordering of preferences, there is no such ordering for the token values. However, instead, some implementations can leverage the pairwise relationships that make the joint token/preference pairs {y_{wt}, z_{w}=1} and {yₗₜ, zₗ=1} exclusive events, and thus the log odds of the ratio between their probabilities gives a pairwise “ranking” logit score that can be applied in a ranking loss. Converting it to probability gives the probability of the token y_{wt} from the preferred sequence being preferred over yₗₜ conditioned on the event that exactly one of the tokens is preferred. Again, some implementations can apply a hyperparameter β that accounts for misspecification of this model. The remainder of this section described this approach, followed by several approximation approaches that focus on generating gradients that push the posterior scores of the tokens in the preferred sequence up, and those of the tokens in the unpreferred sequence down, through a difference relation between the scores.

Differences between scores of vocabulary tokens can be enhanced by computing the probabilities of the loss in (7) by temperature controlled Softmax scores with temperature β<1. Such enhancements boost the predicted probabilities of tokens in preferred sequences like the reward model application in RLHF.

Specifically, applying similar reasoning to Equation (11), the set of joint token/preference outcomes at time t, {{y_{wt}, z_{w}=1}∪{yₗₜ, zₗ=1}} can constitute a set of exclusive events. Thus the log odds ratio

$$\begin{matrix}{q}_{wl , \leq t} ( v , u ) {=}^{Δ} \frac{{p}_{θ} ( {y}_{wl} = v , {z}_{w} = 1 \vert {y}_{w , < t} )}{{p}_{θ} ( {y}_{lt} = u , {z}_{l} = 1 \vert {y}_{l , < t} )} \\ = log \{ \frac{exp ( {s}_{wtv} )}{exp ( {U}_{wt} )} \cdot \frac{exp ( {U}_{lt} )}{exp ( {s}_{ltv} )} \} \\ = ( {s}_{wtv} - {s}_{ltv} ) - ( {U}_{wt} - {U}_{lt} )\end{matrix} \qquad ( 18 )$$

leads to the probability that y_{w} whose prefix ends in y_{wt} is preferred over yₗ whose prefix ends in yₗₜ predicted by these prefixes conditioned on the event that one of the sequences is preferred over the other. Taking the Sigmoid of (18) applying a negative logarithm with temperature β thus gives a temperature controlled pairwise ranking loss of

$$\begin{matrix}{L}_{R} ( {y}_{w} , {y}_{l} ) = {\sum }_{t = 1}^{T} log [ 1 + exp ( - β \cdot log \frac{{p}_{θ} ( {y}_{wt} , {z}_{w} = 1 \vert {y}_{w , < t} )}{{p}_{θ} ( {y}_{lt} , {z}_{l} = 1 \vert {y}_{l , < t} )} ) ] \\ = - {\sum }_{t = 1}^{T} log \frac{{[ {p}_{θ} ( {y}_{wt} , {z}_{w} = 1 \vert {y}_{w , < t} ) ]}^{β}}{{[ {p}_{θ} ( {y}_{wt} , {z}_{w} = 1 \vert {y}_{w , < t} ) ]}^{β} + {[ {p}_{θ} ( {y}_{lt} , {z}_{l} = 1 \vert {y}_{l , < t} ) ]}^{β}} \\ = {\sum }_{t = 1}^{T} log \{ 1 + exp [ - β \cdot ( {s}_{wt , {y}_{wt}} - {s}_{lt , {y}_{lt}} ) + β \cdot ( {U}_{wt} - {U}_{lt} ) ] \}\end{matrix} \qquad ( 19 )$$

A temperature of β=1 gives a loss which sums the negative logarithms of the per token-pairs conditional probabilities. Instead of pushing the preferred and nonpreferred probabilities up and down, respectively, away from the base ones, the loss in (19) pushes them up or down independently of the base probabilities. This is not like RLHF, which, without KL regularization towards the base model, would push the reward indefinitely. Here, the model tries to match the conditional probabilities of token/preference pairs to those of the true token/preference distribution. Applying a temperature β<1 would enhance the learned posterior scores, effectively emphasizing differences between posterior predictions of preferred and non-preferred sequences.

Similarly to (14), the loss can also be applied per-token instead of per-sequence, providing a solution more suitable for sequential decoding, which is aligned with the decoding objective. The advantage of the method in (19) over (13)-(14) is that it can be applied without the need to store the reference predictions or the reference model in order to apply fine-tuning. The loss in (19) can be applied on incremental predictions of the token/preference pair, which keep predicting the same preference label for each of the two sequences, for example in contrast to approaches that apply a single per-sequence-pair loss.

Alternative simplified pairwise losses which push the logit scores of tokens in preferred sequences up and of those of nonpreferred sequences down can be derived as simplifications of (19). An example pairwise loss on the posterior scores st between two sequences is given by

$${L}_{R} ( {y}_{w} , {y}_{l} ) = {\sum }_{t = 1}^{T} log \{ 1 + exp [ β \cdot ( {s}_{lt , {y}_{lt}} - {s}_{wt , {y}_{wt}} ) ] \} \qquad ( 20 )$$

The loss in (20) is a temperature-controlled cross entropy loss on the Sigmoid of the score difference between the posterior score of the tokens of the preferred sequence and those of the unpreferred one, implicitly assuming that U_{wt}≈Uₗₜ. Again, the hyperparameter β for β<1 can enhance the effect of score differences.

Some example implementations can also define a log-odds ratio between the posterior probability of a token taking value v conditioned on a positive preference label and its complement probability to be used in a ranking loss. Contrary to (19), such a loss assumes independence between the preferred and nonpreferred token/preference pairs. From (5),

$${w}_{tv} {=}^{Δ} log \frac{{p}_{θ} ( {y}_{t} = v \vert {y}_{< t} , z = 1 )}{{p}_{θ} ( {y}_{t} \neq v \vert {y}_{< t} , z = 1 )} = log \frac{exp ( {s}_{tv} )}{exp ( {S}_{t} ) - exp ( {s}_{tv} )} \qquad ( 21 )$$

Alternatively, the ratio wₜᵥ can be defined on the joint probability of yₜ and z as defined in (5), but such a definition assumes correlation between the pairs through the joint distribution. Applying a pairwise loss gives

$${L}_{R} ( {y}_{w} , {y}_{l} ) = {\sum }_{t = 1}^{T} log \{ 1 + exp [ β \cdot ( {w}_{lt , {y}_{lt}} - {w}_{wt , {y}_{wt}} ) ] \} \qquad ( 22 )$$

The loss pushes the posterior logit scores s_{wt,y}_{_{wt}} of the preferred sequence up and s_{lt,y}_{ₗₜ} of the unpreferred one down. The posterior logit scores of other tokens v∈V in the vocabulary for the preferred sequence are pushed down, and those of the unpreferred sequence, up. The loss in (22) can also be supplemented by a temperature β on the logit score difference as in (15). It can also be weighted with a hyperparameter ξ with (19). Both losses can be weighted with hyperparameter a with the pointwise loss (7), which can be used to calibrate the pairwise losses. A similar methodology can apply listwise ranking losses, and losses with nonbinary preference labels.

Another option is applying a ranking loss on the probability of the preference label marginalized over all token values. Define

$${q}_{t} {=}^{Δ} log \frac{{p}_{θ} ( z = 1 \vert {y}_{< t} )}{{p}_{θ} ( z \neq 1 \vert {y}_{< t} )} = log {\sum }_{v ∈ V} exp ( {s}_{lv} ) = {S}_{t} \qquad ( 23 )$$

$$Then ,$$

$${L}_{R} ( {y}_{w} , {y}_{l} ) = {\sum }_{t = 1}^{T} log \{ 1 + exp [ {S}_{lt} - {S}_{wt} ] \} \qquad ( 24 )$$

The loss in (24) pushes the scores of the more likely tokens further down for the unpreferred sequence, while pushing the scores of the more likely tokens in the preferred sequence further up. It does push all the preferred sequence scores up, and all the unpreferred sequence scores down. If they are all pushed by the same amount, this does not make a difference for the posterior probabilities. However, it does make a difference in decoders that decode the top-N sequences, and rank among them. Then, unpreferred sequences will be pushed down relative to preferred ones. Even without that, the loss pushes the more likely tokens (including those most likely sampled in the fine-tuning sequence) more aggressively in the correct direction.

Since the loss in (24) is more focused on the preference label, while the losses in (20) and (22) on specific token values, (24) can be superimposed with either the loss in (20) or in (22), where losses are weighted relative to each other by some scaling parameter γ. The ranking losses can still be combined with a pointwise loss as the one in (7) with some hyperparameter α.

A pairwise loss consistent with the distribution defined in (5) and the pointwise loss in (7) defines a log-odds ratio over the distribution in (5) for both the preferred and nonpreferred joint token/preference symbol, assuming independence between the two

$$\begin{matrix}{q}_{wlt ( {y}_{wt} = v )} {=}^{Δ} log \frac{{p}_{θ} ( {y}_{wt} = v , {z}_{w} = 1 \vert {y}_{w , < t} )}{1 - {p}_{θ} ( {y}_{wt} = v , {z}_{w} = 1 \vert {y}_{w , < t} )} \cdot \frac{{p}_{θ} ( {z}_{l} \neq 1 \vert {y}_{l , < t} )}{{p}_{θ} ( {z}_{l} = 1 \vert {y}_{l , < t} )} \\ = log \frac{exp ( {s}_{wtv} )}{exp ( {U}_{wt} ) - exp ( {s}_{wtv} )} \cdot \frac{1}{exp ( {S}_{lt} )} \\ = {s}_{wtv} - {S}_{lt} - log ( exp ( {U}_{wt} ) - exp ( {s}_{wtv} ) )\end{matrix} \qquad ( 25 )$$

The log-odds ratio is not a function of yₗₜ as it aggregates all tokens in the nonpreferred sequence into a single negative preference symbol. The loss is given by

$${L}_{R} ( {y}_{w} , {y}_{l} ) = {\sum }_{t = 1}^{T} log \{ 1 + exp [ - {q}_{wlt} ( {y}_{wt} ) ] \} \qquad ( 26 )$$

pushing the score of the preferred token up, and all scores of other vocabulary tokens in the preferred and nonpreferred sequence, down. Again, the loss in (26) can enhance differences by applying a temperature parameter β<1 inside the exponent.

As before, gradients for fine-tuning parameters can optionally be restricted only to the per-token parameters to avoid multiple parallel updates of parameters of earlier tokens, when sequence updates are applied in parallel for all tokens.

### Example Gated, Low-Rank and Prompt Tuning

The descriptions above focused on the fine-tuning preference loss design to fine-tune to posterior token predictions conditioned on positive preferences. Another aspect of the present disclosure relates to the architecture of the fine-tuning parameters that absorb the fine-tuning loss, especially when the parameters of the pre-trained reference model are frozen.

The techniques described can work with multiple architectures of the fine-tuned parameters. As one example, the Gated LOw Ranking Inference (GLORI) approach was presented with reference to FIG. 2. Some example implementations can simplify it to an additive method as in FIG. 4 which resembles LoRA tuning. Additional implementations can leverage LoRA tuning with a low rank set of parameters on different layers of the pre-trained transformer model.

Yet further approaches can learn a prefix prompt for preferred or nonpreferred sequences. Example implementations can either learn an embedding for each of the categories, or learn the same embedding with a positive/negative prefix. In either case, for training the fine-tuned model, example implementations can plug in the prefix which aligns with the sequence label, and use the same top architecture to apply the loss on the sampled sequence or pairs of sequences, propagating the gradients to learn the prefix prompt embeddings.

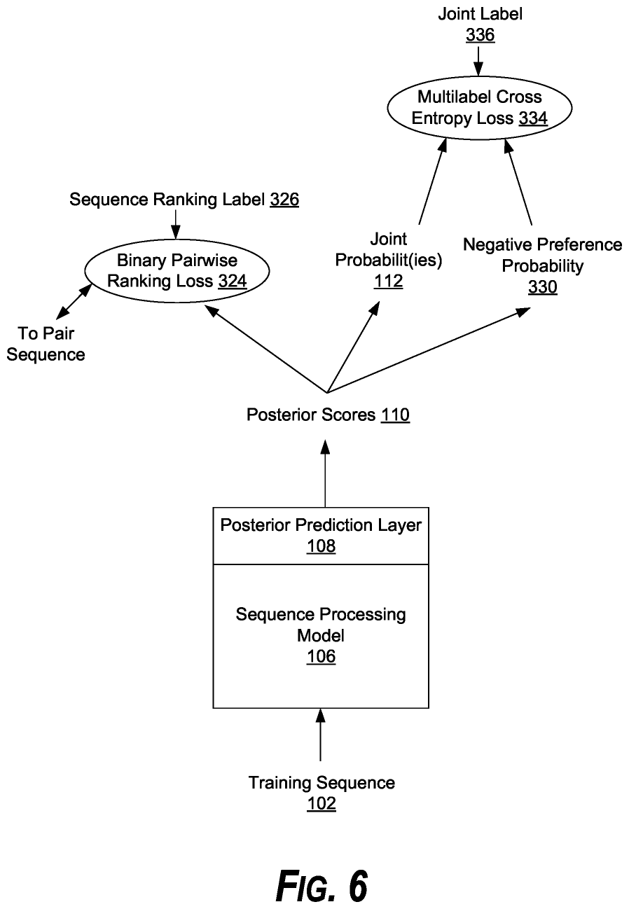

An example of this approach is illustrated in FIG. 7. In particular, FIG. 7 illustrates single-head and multi-objective direct posterior preference fine-tuning (DPPFT) with prefix prompt tuning. The top of the diagram is identical to FIGS. 4 and 5, but instead of tuning internal hidden low-rank top layers towards the preference labels, prefix embeddings are instead being tuned. Some example implementations can have prompts of sufficient length that will attribute credit internally for multiple preference predictions per sequence. Although FIG. 7 illustrates the example prefix prompt tuning approach in the context of a single-head and multi-objective implementation, the prefix prompt tuning approach represents an option for structuring the parameters to be finetuned. Thus, the prefix prompt tuning approach can also be applied in any of the other training settings described herein (e.g., multi-head, multi-objective; joint and base predictions; etc.). The prefix prompt tuning can also be combined with other approaches for structuring finetuning such as, the prefix prompt tuning combined with the GLORI tuning, or other combinations.

### Example Methods

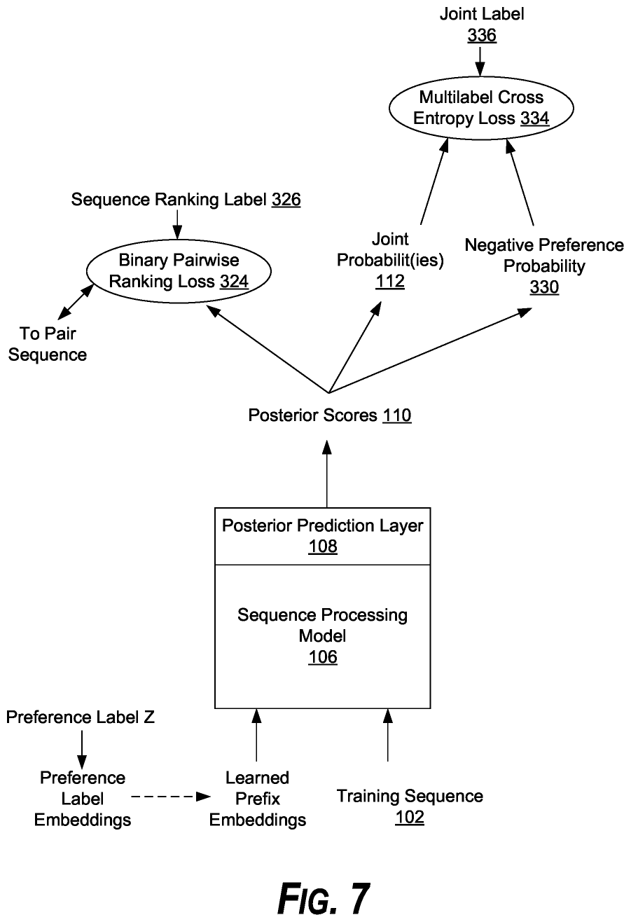

FIG. 8 depicts a flowchart of a method 800 for training or fine-tuning one or more machine-learned models according to aspects of the present disclosure. For instance, an example machine-learned model can include a sequence processing model.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

In some implementations, at 802 of the method 800, a training tuple is obtained that includes a training sequence composed of a series of tokens, along with an associated preference label. This preference label indicates whether the training sequence is favored or not, effectively providing a guide for the model to learn which sequences are considered desirable.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

In some implementations, at 804, the computing system processes at least a portion of the sequence of tokens in the training sequence using the sequence processing model. This step generates an output from a posterior prediction layer of the sequence processing model, which consists of a plurality of posterior scores for a multitude of candidate token values included in the token vocabulary. These posterior scores are conditioned on the assumption that the preference label is a positive label, meaning the sequence is preferred.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning).

In some implementations, at 806, receiving the evaluation signal can include evaluating a first loss function. In some implementations, evaluating the first loss function can include determining a joint probability for the actual token value and the preference label being a positive label based on the posterior scores. This determination of the joint probability can include implicitly or explicitly aggregating all joint probabilities of the candidate token values and the preference label being a negative label into an additional aggregated symbol.

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.). In some implementations, after the performance of method 800, the sequence processing model may be deployed to perform inference. During inference, the posterior scores output by the posterior prediction layer can be utilized to directly model the posterior probability of the candidate token values given an input prompt. For example, the output tokens can be then sampled according to this posterior probability, effectively using the model's learned preferences to influence the generation of token sequences.

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)).

### Example Machine-Learned Models

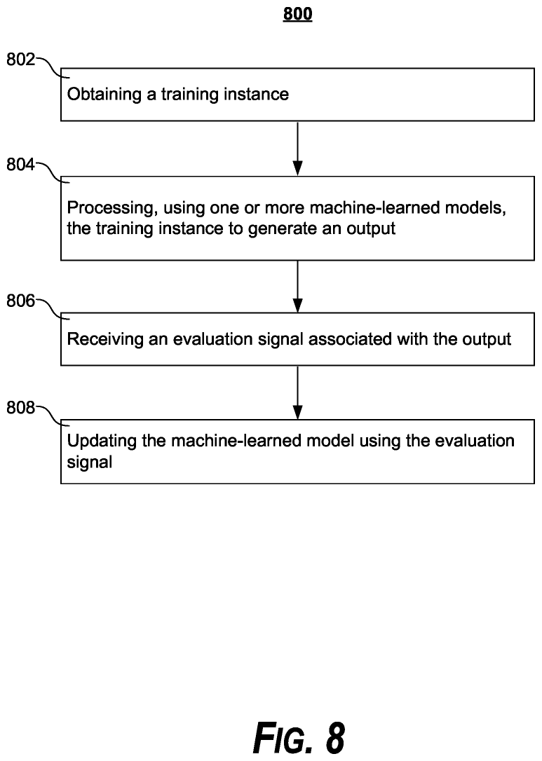

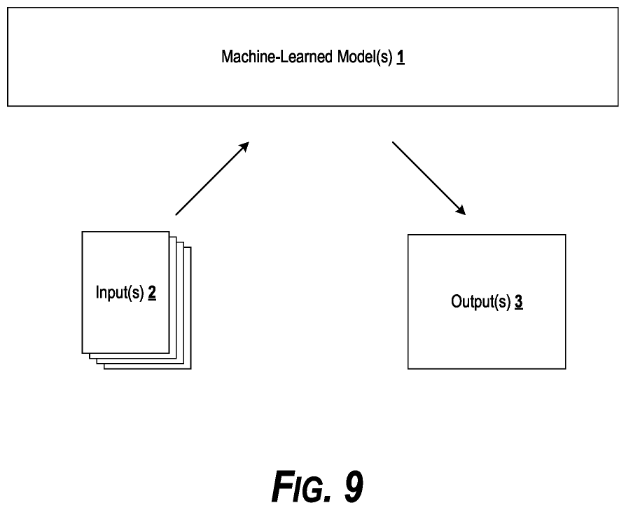

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same typ_{θ}(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data typ_{θ}(s) of input 2 can be the same as or different from the data typ_{θ}(s) of output 3. It is to be understood that the example data types noted above are provided for illustrative purposes only. Data types contemplated within the scope of the present disclosure are not limited to those examples noted above.

### Example Machine-Learned Sequence Processing Models

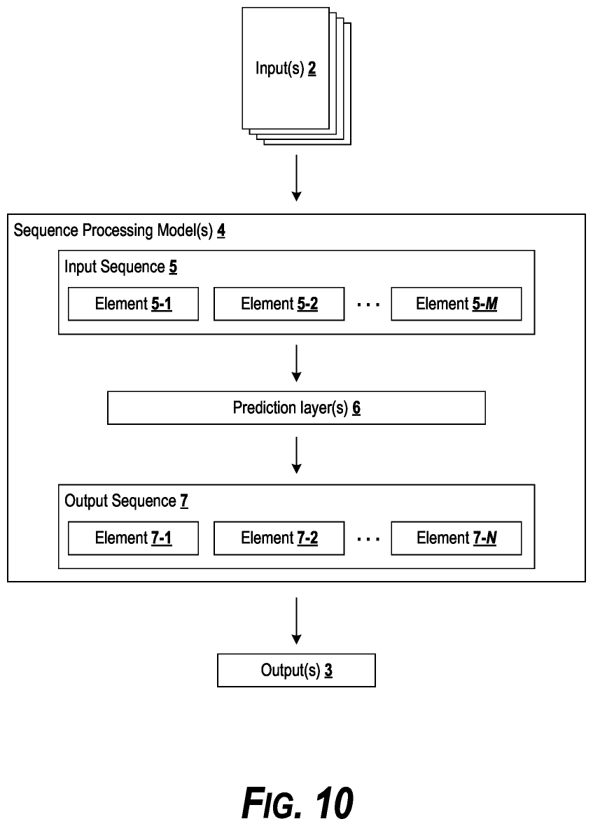

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingestv generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., Sentence Piece: A simple and language independent subword tokenizer and detokenizer for Neural Text Processing, PROCEEDINGS OF THE 2018 CONFERENCE ON EMPIRICAL METHODS INNATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

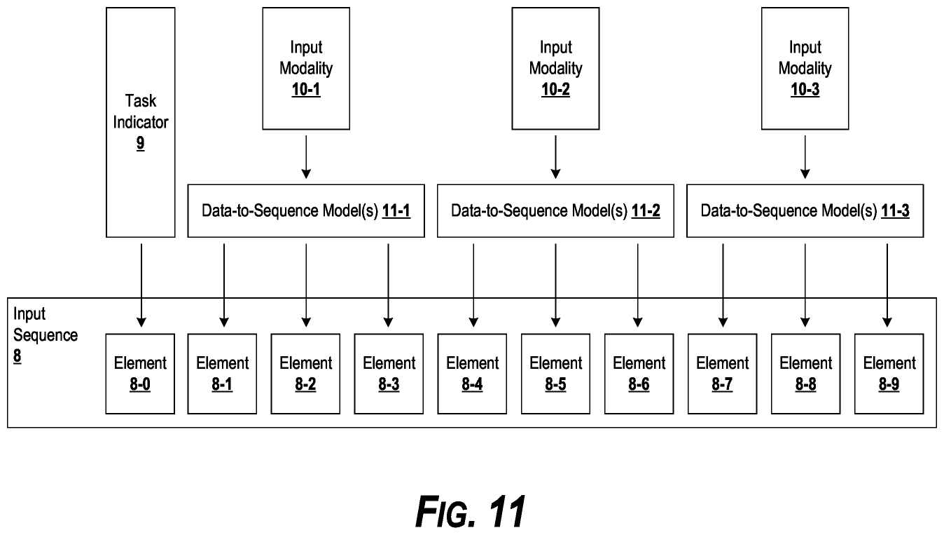

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

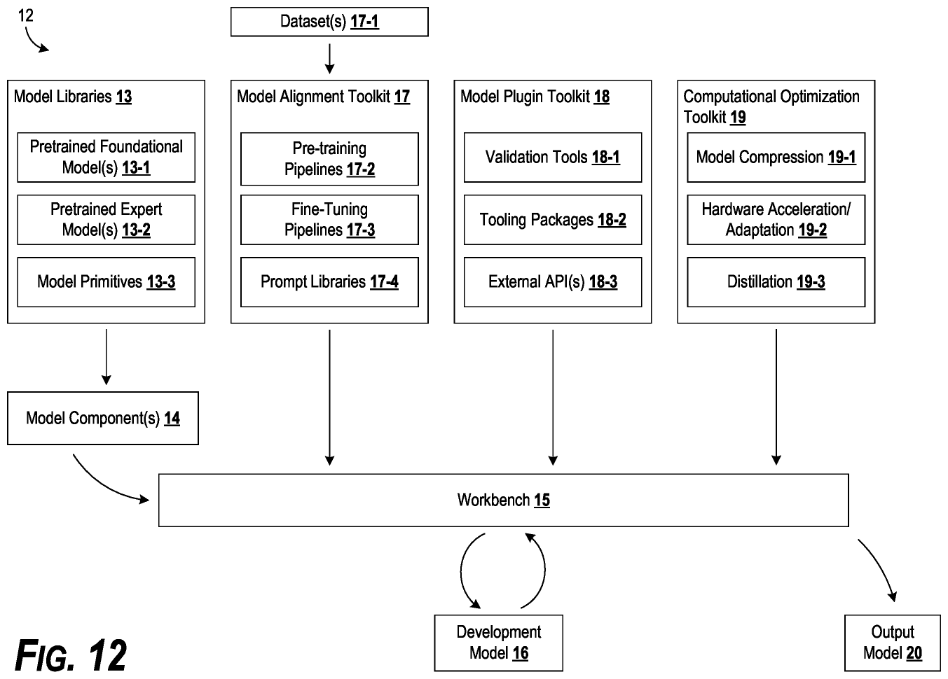

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

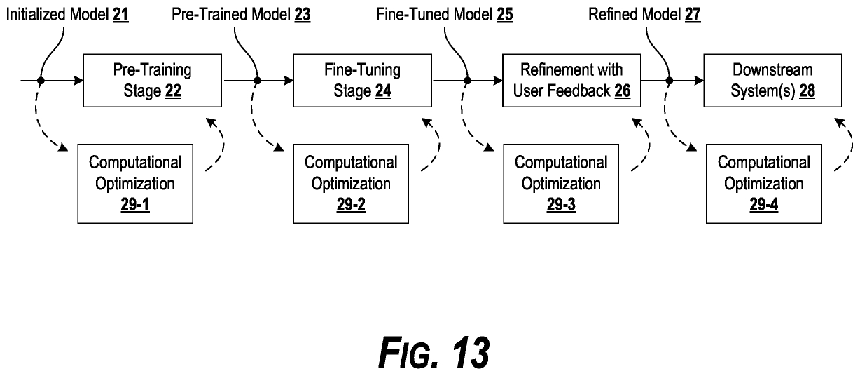

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state of development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

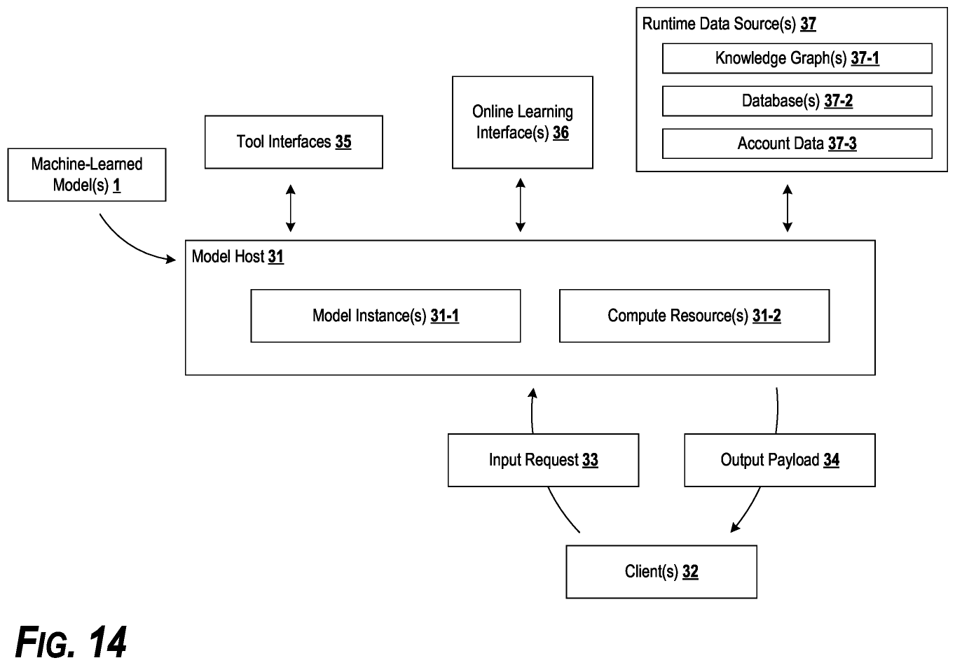

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data typ_{θ}(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

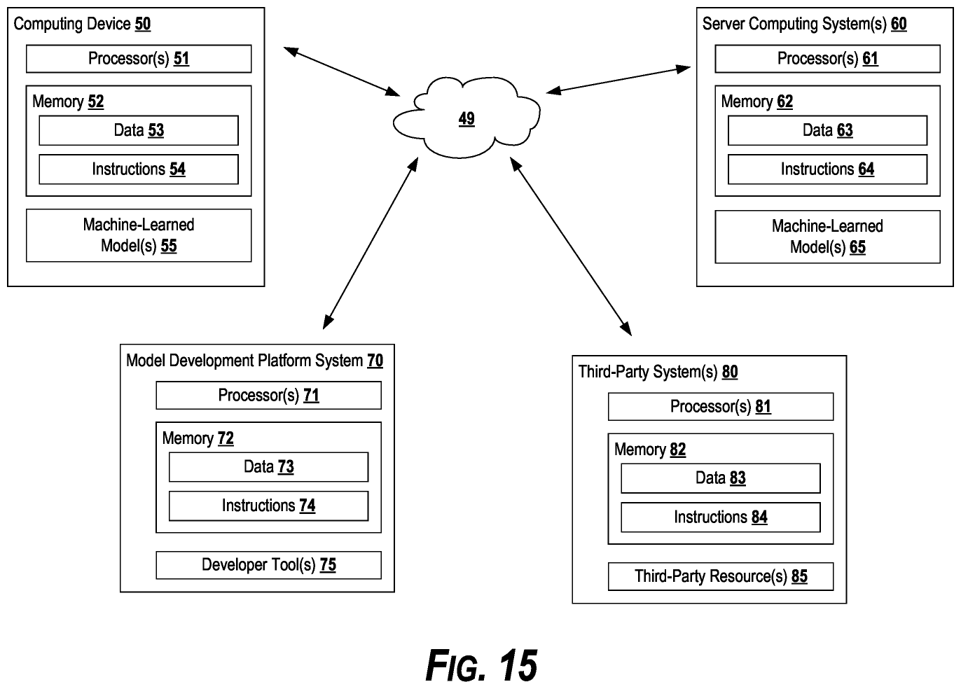

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., castv streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

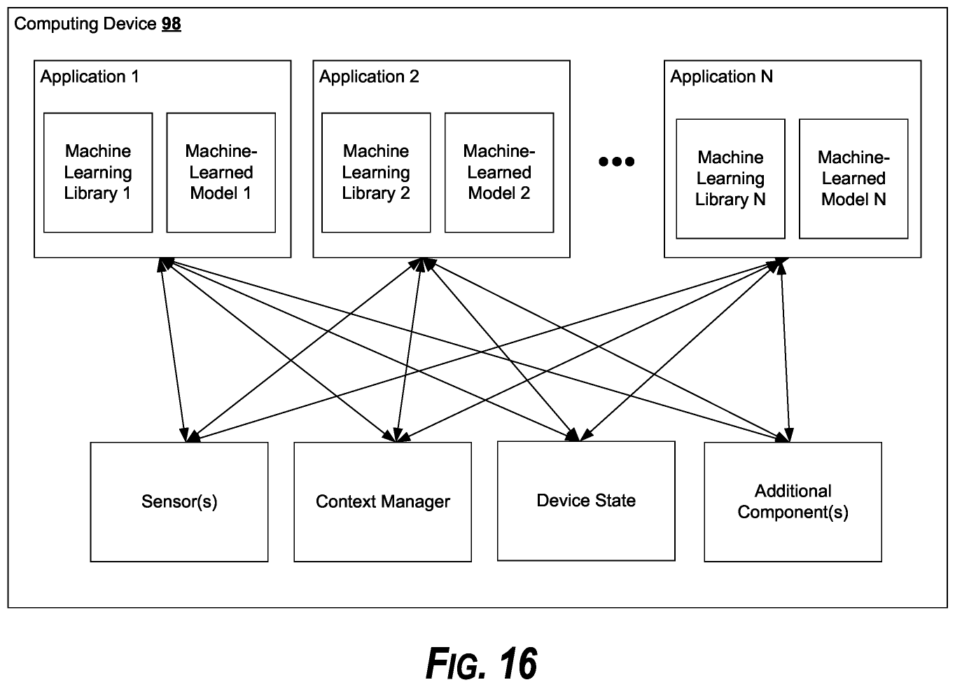

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

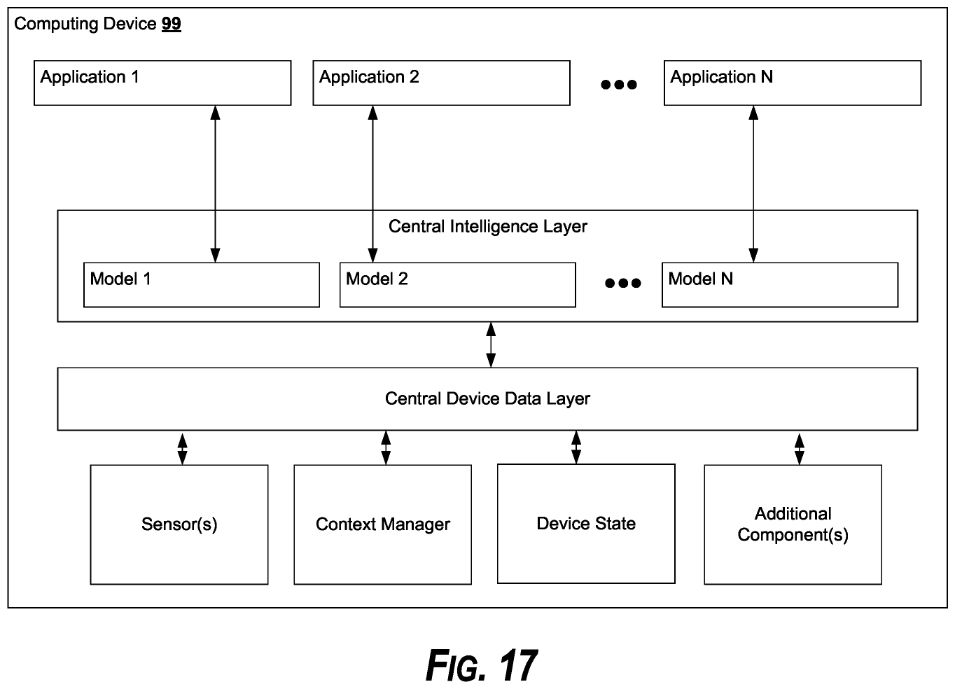

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for performing direct posterior preference fine-tuning of a sequence processing model, the method comprising:
obtaining, by a computing system comprising one or more computing devices, a training tuple comprising a training sequence and a preference label associated with the training sequence, wherein the training sequence comprises a sequence of tokens;
processing, by the computing system, at least a portion of the sequence of tokens in the training sequence with the sequence processing model to generate, as an output of a posterior prediction layer of the sequence processing model, a plurality of posterior scores respectively for a plurality of candidate token values included in a token vocabulary, wherein the plurality of posterior scores are conditioned on the preference label being a positive label;
evaluating, by the computing system, one or more loss functions based on the plurality of posterior scores and the preference label;
wherein evaluating a first loss function of the one or more loss functions comprises determining, by the computing system and based on the plurality of posterior scores, a joint probability for at least an actual token value of the plurality of candidate token values and the preference label being a positive label; and
wherein determining the joint probability comprises aggregating all joint probabilities of the candidate token values and the preference label being a negative label to an additional aggregated symbol; and
modifying, by the computing system, one or more values of one or more parameters of the sequence processing model based on the one or more loss functions including the first loss function.

2. The computer-implemented method of claim 1, further comprising, after said modifying:
deploying, by the computing system, the sequence processing model to perform inference, wherein, during inference, the posterior scores output by the posterior prediction layer of the sequence processing model are used to directly model a posterior probability of the candidate token values given an input prompt and output tokens are sampled according to the posterior probability.

3. The computer-implemented method of claim 1, wherein evaluating, by the computing system, the one or more loss functions and modifying, by the computing system, the one or more values of the one or more parameters of the sequence processing model based on the one or more loss functions are performed on a per-token incremental basis.

4. The computer-implemented method of claim 1, further comprising:
processing, by the computing system, at least the portion of the sequence of tokens in the training sequence with the same or a different sequence processing model to generate, as an output of a reference prediction layer, a plurality of reference scores respectively for the plurality of candidate token values included in the token vocabulary;
wherein evaluating the first loss function comprises:
determining, by the computing system, a reference probability for an actual token value in the training sequence based on the plurality of reference scores; and
determining, by the computing system, a conditional preference prediction based on the joint probability and the reference probability for the actual token value;
wherein the first loss function generates a loss value based on the conditional preference prediction and the preference label.

5. The computer-implemented method of claim 4, wherein modifying the one or more values of the one or more parameters of the sequence processing model comprises modifying one or more values of one or more parameters of the posterior prediction layer while holding the reference prediction layer fixed.

6. The computer-implemented method of claim 1, further comprising:
retrieving, by the computing system from a computer-readable storage, a reference probability for an actual token value in the training sequence; and
wherein evaluating the first loss function comprises determining, by the computing system, a conditional preference prediction based on the joint probability and the reference probability for the actual token value;
wherein the first loss function compares the conditional preference prediction to the preference label.

7. The computer-implemented method of claim 1, further comprising:
processing, by the computing system, at least the portion of the sequence of tokens in the training sequence with the sequence processing model to generate, as an output of a reference prediction layer of the sequence processing model, reference scores respectively for a subset of the plurality of candidate token values included in the token vocabulary;
processing, by the computing system, at least the portion of the sequence of tokens in the training sequence with the sequence processing model to generate, as an output of a normalization prediction layer of the sequence processing model, a normalizer score;
wherein evaluating the first loss function comprises:
determining, by the computing system, a reference probability for the subset of the plurality of candidate token values based on the reference scores and the normalizer score; and
determining, by the computing system, a conditional preference prediction based on the joint probability and the reference probability;
wherein the first loss function compares the conditional preference prediction to the preference label.

8. The computer-implemented method of claim 7, wherein the preference label comprises a binary preference label and the first loss function comprises a binary cross entropy loss.

9. The computer-implemented method of claim 7, wherein the training tuple comprises the training sequence and at least one additional, paired training sequence, wherein the preference label comprises a pairwise ranking label, and wherein the first loss function comprises a binary pairwise ranking loss.

10. The computer-implemented method of claim 1, wherein the first loss function comprises a multilabel cross entropy loss that increases the posterior scores of token values associated with a positive preference label and decreases the posterior scores of all token values for a negative preference label.

11. The computer-implemented method of claim 1, further comprising:
processing, by the computing system, at least the portion of the sequence of tokens in the training sequence with the sequence processing model to generate, as an output of a preference prediction layer of the sequence processing model, a preference score for at least the actual token value in the training sequence;
wherein evaluating, by the computing system, the one or more loss functions comprises evaluating a second loss function that generates a loss value based on the preference score, wherein the second loss function comprises a pairwise loss function that operates to directly compare the preference score generated for the training sequence with a different preference score generated for a different, paired training sequence included in or associated with the training tuple.

12. The computer-implemented method of claim 1, wherein evaluating, by the computing system, the one or more loss functions comprises evaluating a pairwise loss function that generates a loss value based on the plurality of posterior scores generated for the training sequence and other posterior scores generated for a different, paired training sequence included in or associated with the training tuple.

13. The computer-implemented method of claim 1, wherein modifying, by the computing system, the one or more values of the one or more parameters of the sequence processing model based on the one or more loss functions comprises modifying, by the computing system, values of all of the parameters of the sequence processing model based on the one or more loss functions.

14. The computer-implemented method of claim 1, wherein modifying, by the computing system, the one or more values of the one or more parameters of the sequence processing model based on the one or more loss functions comprises modifying, by the computing system, values of only a subset of parameters that have been added to the sequence processing model while holding pre-trained parameters of the sequence processing model fixed.

15. The computer-implemented method of claim 14, wherein the subset of parameters that have been added to the sequence processing model comprise low rank adaptation parameters.

16. The computer-implemented method of claim 14, wherein the subset of parameters that have been added to the sequence processing model comprise gated low rank inference parameters.

17. The computer-implemented method of claim 1, wherein modifying, by the computing system, the one or more values of the one or more parameters of the sequence processing model based on the one or more loss functions comprises modifying, by the computing system, values of a prefix prompt that is prepended to the training sequence.

18. The computer-implemented method of claim 1, wherein the plurality of candidate token values consists of a top-K set of candidate token values.

19. A computing system configured to perform sequence processing with improved computational efficiency, the computing system comprising:
one or more processors; and
one or more non-transitory computer-readable media that collectively store:
a machine-learned sequence processing model comprising a posterior prediction layer configured to generate a plurality of posterior scores respectively for a plurality of candidate token values included in a token vocabulary, the plurality of posterior scores conditioned on a positive preference; and
computer-executable instructions that, when executed by the one or more processors, cause the computing system to perform operations, the operations comprising:
obtaining an input prompt;
processing the input prompt with the machine-learned sequence processing model to generate, as an output the posterior prediction layer, the plurality of posterior scores respectively for the plurality of candidate token values included in the token vocabulary;
transforming the plurality of posterior scores into a plurality of posterior probabilities respectively for the plurality of candidate token values; and
sampling an output token for inclusion in an output sequence of tokens based on the plurality of posterior probabilities respectively for the plurality of candidate token values.

20. The computing system of claim 19, wherein the machine-learned sequence processing model has been trained using a loss function, wherein evaluation of the loss function included determining a joint probability for an actual token value in an actual training fine-tuning sequence and the positive preference, and wherein determining the joint probability included aggregating all joint probabilities of the candidate token values and a negative preference to an additional aggregated symbol.

21. The computing system of claim 19, wherein the machine-learned sequence processing model was trained on a per-token incremental basis.

22. The computing system of claim 19, wherein one or both of the input prompt and the output sequence of tokens comprise textual tokens, image tokens, video tokens, audio tokens, programming-language tokens, or combinations thereof.
